(19) United States
(12) Patent Application Publication
(10) Pub. No.: US 2023/0386100 A1
(43) Pub. Date: Nov. 30, 2023

(54) COLOR SELECTING METHOD AND COLOR SELECTING APPARATUS

(71) Applicant: Wacom Co., Ltd., Saitama (JP)

(72) Inventors: Ipei HUNG, Saitama (JP); Akiyuki KAKE, Saitama (JP); Kizuku ISHIMARU, Saitama (JP)

(21) Appl. No.: 18/449,612

(22) Filed: Aug. 14, 2023

Related U.S. Application Data
(63) Continuation of application No. PCT/JP2022/002787, filed on Jan. 26, 2022.

(30) Foreign Application Priority Data
Feb. 17, 2021 (JP) 2021-023042

(51) Int. Cl. G06T 11/00; G06T 11/20; G06F 3/0354

(52) U.S. Cl. CPC G06T 11/001; G06F 3/03545; G06T 11/203

(57) ABSTRACT

Provided is a color selecting method in an information processing device that perform signal interaction with a position indicator, the color selecting method including detecting a circular motion operation of the position indicator and selecting a hue, detecting a rectilinear motion operation of the position indicator and selecting a first one of a saturation or a lightness, detecting a displacement quantity or a displacement position based on a movement of the position indicator in a direction intersecting a direction of the rectilinear motion operation and selecting a second one of the saturation or the lightness, and selecting a color based on the hue selected according to the circular motion operation, the first one of the saturation or the lightness selected according to the rectilinear motion operation, and the second one of the saturation or the lightness selected according to the displacement quantity or the displacement position.

### BACKGROUND

### Technical Field

The present disclosure relates to a color selecting method and a color selecting apparatus suitable for use in a case of, for example, selecting the color of a drawing image by using a position indicator and the like.

### Description of the Related Art

There has hitherto been provided a color image display device which allows the color of an image displayed on a display to be changed by a color selecting operation performed by a user. For example, Japanese Patent Laid-Open No. Sho 59-197085 (Patent Document 1) discloses a color selecting method that allows the color of a pixel at a position Po selected by a cursor CS to be changed to a color of a hue, a saturation, and a lightness desired by the user with use of a hue selecting key F1, a saturation selecting key F2, and a lightness selecting key F3 of a keyboard KB, in an image displayed on a display screen DP, as illustrated in FIG. 16A.

In the example of Patent Document 1, as for hue, as illustrated in FIG. 16B, different hues are assigned in advance at intervals of an angular range of 20 degrees, for example, in the circumferential direction of a circle, and each time the user presses the hue selecting key F1, a change can sequentially be made to a hue at an interval of the angular range of 20 degrees.

In addition, as for saturation, within a change range of 0% to 100%, each time the user presses the saturation selecting key F2, a change can sequentially be made to a saturation that differs by 25%, for example.

Further, as for lightness, within a change range of 0% (dark) to 100% (light), each time the user presses the lightness selecting key F3, a change can sequentially be made to a lightness that differs by 10%, for example.

Hence, with the color selecting method described in Patent Document 1, the user selects a desired color by selecting and switching to the hue selecting key F1, the saturation selecting key F2, and the lightness selecting key F3 as appropriate, and operating the respective keys an appropriate number of times.

However, the color selecting method of Patent Document 1 necessitates an operation of selecting one of the three keys which is assigned one of hue, saturation, and lightness as three elements of color and an element changing operation for each of hue, saturation, and lightness with use of each key. In addition, each key needs to be operated an appropriate number of times as element changing operation for each of hue, saturation, and lightness. Thus, operations for color selection are troublesome, and it takes time for the user to achieve a color of a hue, a saturation, and a lightness that is desired.

### BRIEF SUMMARY

It is an object of the present disclosure to provide a color selecting method that can solve the above problems.

In order to solve the above problems, there is provided a color selecting method in an information processing device that performs signal interaction with a position indicator, the color selecting method including detecting a circular motion operation of the position indicator according to the signal interaction with the position indicator, and selecting a hue according to the circular motion operation, detecting a rectilinear motion operation of the position indicator according to the signal interaction with the position indicator, and selecting a first one of a saturation or a lightness according to the rectilinear motion operation, detecting a displacement quantity or a displacement position based on a movement of the position indicator in a direction intersecting a direction of the rectilinear motion operation, according to the signal interaction with the position indicator, and selecting a second one of the saturation or the lightness according to the displacement quantity or the displacement position based on the movement of the position indicator in the direction intersecting the direction of the rectilinear motion operation, and selecting a color based on the hue selected according to the circular motion operation, the first one of the saturation or the lightness selected according to the rectilinear motion operation, and the second one of the saturation or the lightness selected according to the displacement quantity or the displacement position.

Moreover, in the color selecting method described above, preferably, the detecting the circular motion operation of the position indicator includes detecting an angular position on a circumference in the circular motion operation of the position indicator, according to the signal interaction with the position indicator, and the selecting the hue includes selecting the hue according to the angular position from among different hues assigned according to angular positions on the circumference, the detecting the rectilinear motion operation of the position indicator includes detecting a position on a straight line in the rectilinear motion operation of the position indicator according to the signal interaction with the position indicator, and the selecting the first one of the saturation or the lightness includes selecting the first one of the saturation or the lightness according to the detected position on the straight line from among one of a saturation group or a lightness group that is assigned different values according to positions on the straight line, and the detecting the displacement quantity or the displacement position includes detecting the displacement quantity or the displacement position based on the movement of the position indicator in the direction intersecting the direction of the rectilinear motion operation according to the signal interaction with the position indicator, and the selecting the second one of the of the saturation or the lightness includes selecting the second one of the saturation or the lightness according to the detected displacement quantity or the detected displacement position in a displacement of a state of the position indicator from among the second one of the saturation group or the lightness group that is assigned different values according to displacement quantities or displacement positions based on movements of the position indicator in the direction intersecting the direction of the rectilinear motion operation.

In the color selecting method having the above-described configuration, the position indicator usable when a color display image is drawn, for example, is used as an instrument (tool) for color selection. Moreover, the information processing device that performs signal interaction with the position indicator detects the movements of the position indicator, selects a hue, selects a saturation, and selects a lightness according to the detected movements, and thereby makes a color selection.

In a preferable configuration, the information processing device has information regarding hues assigned in such a manner as to be different according to the angular positions on the circumference, information regarding each saturation assigned in such a manner as to be different according to positions on the straight line, and information regarding each lightness assigned in such a manner as to be different according to displacement quantities or displacement positions in the direction intersecting the direction of the rectilinear motion operation of the position indicator.

In the selecting of the hue, the information processing device detects an angular position on the circumference in the circular motion operation of the position indicator according to the signal interaction with the position indicator. Then, the information processing device selects a hue according to the detected angular position from the information regarding the hues described above.

In addition, in the selecting of the saturation, the information processing device detects a position on the straight line in the rectilinear motion operation of the position indicator according to the signal interaction with the position indicator, and selects a saturation according to the detected position on the straight line.

Further, in the selecting of the lightness, the information processing device detects a displacement quantity or a displacement position in displacement of a state of the position indicator in the direction intersecting the direction of the rectilinear motion operation of the position indicator, according to the signal interaction with the position indicator, and selects a lightness according to the detected displacement quantity or the detected displacement position.

That is, in the color selecting method of the above-described configuration, a user performs a circular motion operation of the position indicator, changes a hue by changing an angular position in the circular motion operation, and thereby selects a desired hue. In addition, the user performs a rectilinear motion operation of the position indicator, and selects a saturation by changing a position in the rectilinear motion operation. Further, the user displaces the state of the position indicator in the direction intersecting the direction of the rectilinear motion operation of the position indicator, and selects a lightness by changing a displacement quantity or a displacement position in the displacement of the state.

Hence, the user can select a color of a hue, a saturation, and a lightness that are desired, by performing the circular motion operation, the rectilinear motion operation, and the state displacement operation with use of the position indicator. A color selecting operation is thus simplified.

In addition, in the color selecting method of the above-described configuration, a hue is selected by performance of a circular motion operation of the position indicator along the direction of the circumference assigned the hues, a saturation is selected by performance of a rectilinear motion operation of the position indicator along the direction of the straight line assigned the saturation, and a lightness is selected by performance of state displacement of the position indicator along the direction that is assigned the lightness and that intersects the direction of the rectilinear motion operation. That is, the movements of the position indicator for selecting the hue, the saturation, and the lightness correspond to the change directions of the hue, the saturation, and the lightness. Thus, there is another advantage in that the user can select the hue, the saturation, and the lightness intuitively according to the movements of the position indicator.

### BRIEF DESCRIPTION OF THE SEVERAL VIEWS OF THE DRAWINGS

FIG. 1 is a diagram of assistance in explaining an outline of a configuration of a color selecting apparatus according to a first embodiment of the present disclosure;

FIG. 2 is a diagram of assistance in explaining an example of a hardware configuration of a tablet device as an example of an information processing device of the color selecting apparatus in the first embodiment in FIG. 1;

FIG. 3 is a block diagram illustrating an example of an electric configuration of the tablet device as an example of the information processing device of the color selecting apparatus in the first embodiment in FIG. 1;

FIGS. 4A, 4B, and 4C are diagrams used to explain a color selecting method according to the first embodiment of the present disclosure;

FIGS. 5A, 5B, and 5C are diagrams illustrating an example of table information used to explain the color selecting method according to the first embodiment of the present disclosure;

FIG. 6 is a diagram illustrating a part of a flowchart of assistance in explaining a flow of processing in the color selecting method according to the first embodiment of the present disclosure;

FIG. 7 is a diagram illustrating a part of the flowchart of assistance in explaining a flow of processing in the color selecting method according to the first embodiment of the present disclosure;

FIG. 8 is a diagram of assistance in explaining an outline of a configuration of the color selecting apparatus according to a second embodiment of the present disclosure;

FIG. 9 is a block diagram illustrating an example of an electric configuration of an electronic pen as an example of a position indicator of the color selecting apparatus in the second embodiment in FIG. 8;

FIG. 10 is a block diagram illustrating an example of an electric configuration of a tablet device as an example of an information processing of the color selecting apparatus device in the second embodiment in FIG. 8;

FIGS. 11A, 11B, 11C, and 11D are diagrams used to explain the color selecting method according to the second embodiment of the present disclosure;

FIG. 12 is a diagram illustrating a part of a flowchart of assistance in explaining a flow of processing in the color selecting method according to the second embodiment of the present disclosure;

FIG. 13 is a diagram illustrating a part of the flowchart of assistance in explaining a flow of processing in the color selecting method according to the second embodiment of the present disclosure;

FIGS. 14A, 14B, 14C, 14D, and 14E are diagrams used to explain the color selecting method according to a third embodiment of the present disclosure;

FIG. 15 is a diagram illustrating a part of a flowchart of assistance in explaining a flow of processing in the color selecting method according to the third embodiment of the present disclosure; and

FIGS. 16A and 16B are diagrams used to explain an example of a conventional color selecting method.

### DETAILED DESCRIPTION

Embodiments of a color selecting method according to the present disclosure will hereinafter be described together with embodiments of a color selecting apparatus with reference to the drawings.

### First Embodiment

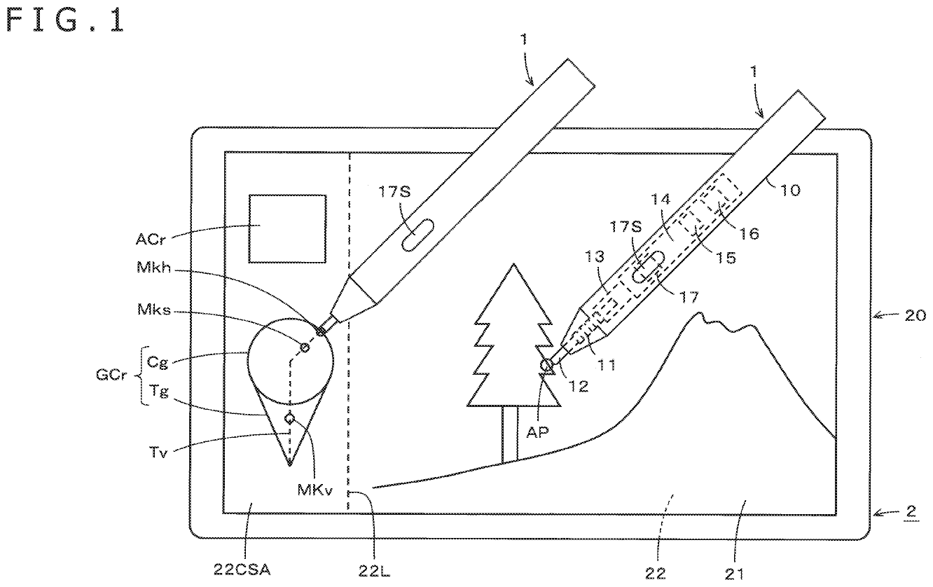

FIG. 1 is a diagram illustrating an outline of the color selecting apparatus according to a first embodiment. The color selecting apparatus according to the present first embodiment includes an electronic pen 1 as an example of a position indicator and a tablet device 2 as an example of an information processing device that performs signal interaction with the electronic pen 1. In the present embodiment, the electronic pen 1 and a position detecting sensor disposed in the tablet device 2 to perform signal interaction with the electronic pen 1 have a configuration of an electromagnetic induction system.

The electronic pen 1 houses, inside a tubular casing 10, a coil 11 wound around a magnetic core not illustrated in FIG. 1, for example, a ferrite core. Moreover, one end side in the axial direction of the tubular casing 10 of the electronic pen 1 has an opening. One end in the axial direction of a rod-shaped core body 12 formed of, for example, resin, the one end constituting a pen tip portion, projects through the opening. The pen tip portion of the core body 12 of the electronic pen 1 constitutes a position indicating portion of the electronic pen 1 as an example of a position indicator.

The core body 12 is attached in a state of being inserted in a through hole in the axial direction which is formed in the ferrite core. An end portion of the core body 12 which is on an opposite side from the pen tip portion side is fitted to a pressure detector 13 attached in a state of being immovable in the axial direction inside the casing 10.

The pressure detector 13 is configured to detect a reaction force (pressure (pen pressure)) generated by the pen tip portion of the core body 12 of the electronic pen 1 being pressed against an input surface, as an electric change such as a change in capacitance, a change in an inductance value, or a change in resistance. In the present example, the pressure detector 13 includes a section that detects the pressure (pen pressure) as a change in capacitance, and, for example, has a configuration in which capacitance is changed by a change in an area of contact between a dielectric and a conductive elastic member according to the applied pressure (see, for example, Patent Document; Japanese Patent Laid-open No. 2016-126503).

Moreover, a circuit board 14 is provided inside the casing 10 of the electronic pen 1. The circuit board 14 includes capacitors 15 and 16 that form a resonance circuit together with the coil 11. In addition, in the present example, the circuit board 14 includes a switch (side switch) 17 that is turned on and off by a switch operating element 17S. The switch operating element 17S is provided in such a manner as to be exposed outward from a peripheral side surface of the casing 10.

An on operation of the side switch 17 can be set and registered in the tablet device 2 in association with a predetermined event in advance. In the present embodiment, the on operation of the side switch 17 is set and registered in the tablet device 2 to be treated as an operation equivalent to a click operation of a mouse as a pointing device.

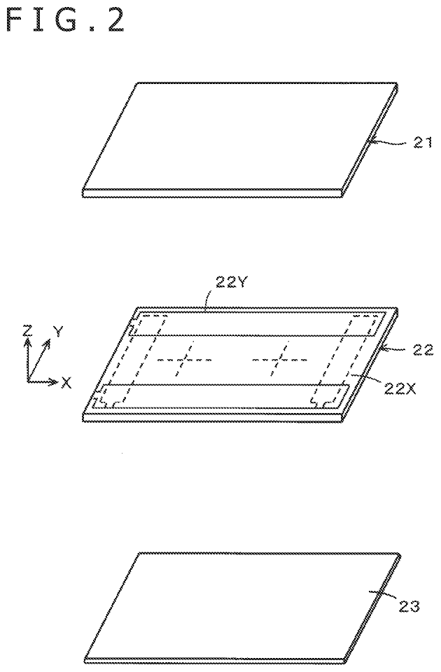

As illustrated in FIG. 1, the tablet device 2 in the present embodiment has a rectangular casing 20 of a flat and thin type. FIG. 2 is an exploded perspective view illustrating constituent parts housed in the casing 20 of the tablet device 2.

As illustrated in FIG. 1 and FIG. 2, the tablet device 2 includes a flat display 21 including a liquid crystal display (LCD), for example. Moreover, an electromagnetic induction type position detecting sensor 22 that performs signal interaction with the electronic pen 1 is provided on the undersurface side of the flat display 21 in the casing 20 of the tablet device 2 in such a manner as to be superposed on the flat display. The position detecting sensor 22 is formed by a plurality of loop coils 22X and 22Y being arranged on a thin substrate.

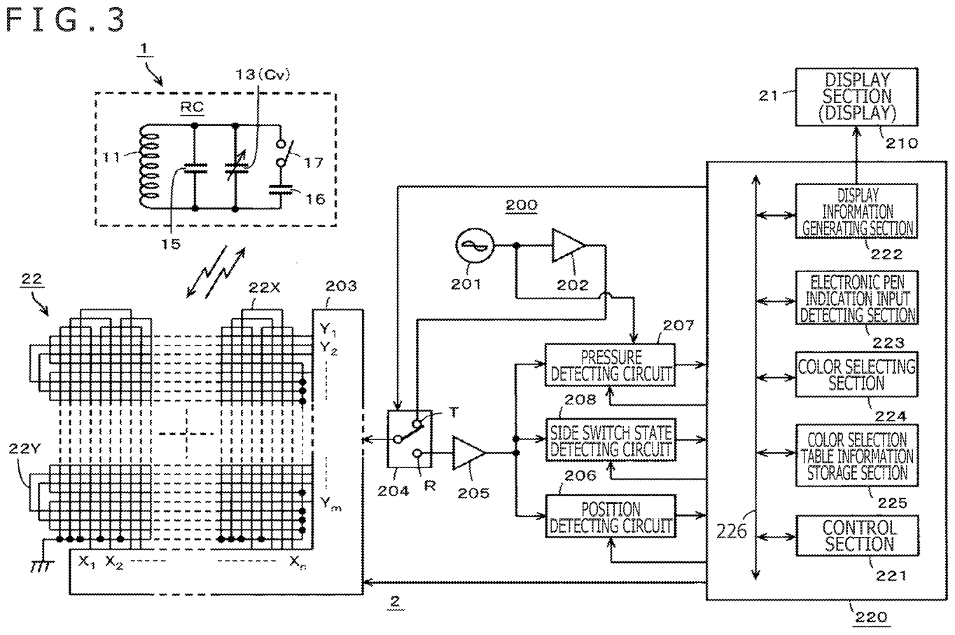

Moreover, a circuit board 23 is further provided on the undersurface side of the position detecting sensor 22 in the casing 20 of the tablet device 2. As illustrated in FIG. 3 to be described later, mounted on the circuit board 23 are a position detecting circuit 200 to which the loop coils 22X and 22Y of the position detecting sensor 22 are connected and an information processing circuit 220 connected to the position detecting circuit 200 and connected to a display section 210 that displays a display image on the flat display 21.

By performing signal interaction with the electronic pen 1 through the position detecting sensor 22, the position detecting circuit 200 detects a position indicated by the electronic pen 1 in a detection region of the position detecting sensor 22, and in the present example, the position detecting circuit 200 detects the pressure applied to the pen tip portion of the core body 12 of the electronic pen 1 and the on/off state of the side switch 17.

The information processing circuit 220 has functions of generating display information for generating a writing trace or a drawing trace of the electronic pen 1 from the information regarding the position indicated by the electronic pen 1 which is detected by the position detecting circuit 200, and supplying the display information regarding the writing trace or the drawing trace to the display section 210 to display the writing trace or the drawing trace on the flat display 21. The information processing circuit 220 also has a function of reflecting the pressure applied to the pen tip portion of the core body 12 of the electronic pen 1 in the display information regarding the writing trace or the drawing trace.

The information processing circuit 220 in the present embodiment also has a function of selecting and designating a display color of the writing trace or the drawing trace of the electronic pen 1, the writing trace or the drawing trace being displayed on the flat display 21, or the like, according to motion of the pen tip portion of the core body 12 of the electronic pen 1 and detection output of the pressure applied to the pen tip portion.

An example of an electric configuration of the electronic pen 1 and the tablet device 2 is illustrated in FIG. 3. In the following, an example of an electric configuration of the electronic pen 1 and an example of an electric configuration of an information processing circuit 410 will be described with reference to FIG. 3.

### Example of Electric Configuration of Electronic Pen 1

As illustrated in FIG. 3, the electronic pen 1 includes a resonance circuit RC formed by connecting the coil 11, the capacitor 15, a variable capacitance capacitor Cv including the pressure detector 13, and a series circuit of the side switch 17 and the capacitor 16 in parallel with one another.

The resonance frequency of the resonance circuit RC (resonance frequency when the side switch 17 is turned off) is configured to be equal to the frequency of a signal transmitted from the tablet device 2. Moreover, the pressure detector 13 detects the pressure applied to the pen tip portion of the core body 12 as a change in the capacitance of the variable capacitance capacitor Cv, and the resonance frequency (phase) of the resonance circuit RC changes according to the pressure detected by the pressure detector 13. That is, the electronic pen 1 transmits the pressure detected by the pressure detector 13, as a change in the resonance frequency (phase) of the resonance circuit RC, to the tablet device 2.

Moreover, when the side switch 17 is turned off, the capacitor 16 is disconnected from the resonance circuit RC, whereas, when the side switch 17 is turned on, the capacitor 16 is connected to the resonance circuit RC, so that the resonance frequency (phase) of the resonance circuit RC changes. That is, the electronic pen 1 transmits the on state and the off state of the side switch 17 as a change in the resonance frequency (phase) of the resonance circuit RC to the tablet device 2.

### Example of Electric Configuration of Tablet Device 2

On the other hand, as illustrated in FIG. 3, the tablet device 2 includes the position detecting sensor 22, the position detecting circuit 200, the display section 210, and the information processing circuit 220. The position detecting sensor 22 is formed by laminating, onto a thin substrate, an X-axis direction loop coil group 22X and a Y-axis direction loop coil group 22Y, the X-axis direction loop coil group 22X being formed by arranging a plurality of loop coils at a predetermined pitch in the horizontal direction (X-axis direction) of the flat display 21, and the Y-axis direction loop coil group 22Y being formed by arranging a plurality of loop coils at a predetermined pitch in the vertical direction (Y-axis direction) of the flat display 21.

The position detecting circuit 200 includes an oscillator 201, a current driver 202, a selecting circuit 203, a switching connecting circuit 204, a receiving amplifier 205, a position detecting circuit 206, a pressure detecting circuit 207, and a side switch state detecting circuit 208. Detection outputs of the position detecting circuit 206, the pressure detecting circuit 207, and the side switch state detecting circuit 208 of the position detecting circuit 200 are supplied to the information processing circuit 220.

The information processing circuit 220 includes a control section 221 including a microprocessor. The information processing circuit 220 controls the operation of the position detecting circuit 200 by the control section 221. That is, the control section 221 of the information processing circuit 220 controls the selection of a loop coil in the selecting circuit 203 of the position detecting circuit 200 and switching of the switching connecting circuit 204, and controls processing timing in the position detecting circuit 206, the pressure detecting circuit 207, and the side switch state detecting circuit 208. In one or more implementations, the microprocessor includes a processor and a memory storing instructions that, when executed the processor, cause the information processing circuit 220 to perform the operations described herein.

The X-axis direction loop coil group 22X and the Y-axis direction loop coil group 22Y of the position detecting sensor 22 are connected to the selecting circuit 203. Under control of the control section 221 of the information processing circuit 220, the selecting circuit 203 sequentially selects one loop coil of the two loop coil groups 22X and 22Y. The oscillator 201 generates an alternating-current signal of a frequency f0. The oscillator 201 supplies the generated alternating-current signal to the current driver 202 and the pressure detecting circuit 207. The current driver 202 converts the alternating-current signal supplied from the oscillator 201 into a current, and sends out the current to the switching connecting circuit 204.

The information processing circuit 220 not only controls the operation of the position detecting circuit 200 but also has, in the present embodiment, a function of generating a display image and displaying the display image on the flat display 21 according to the output of the position detecting circuit 200 and a function of selecting (changing) the color of the image displayed on the flat display 21, according to the output of the position detecting circuit 200.

In order for the information processing circuit 220 to implement these functions, each of a display information generating section 222, an electronic pen indication input detecting section 223, a color selecting section 224, and a color selection table information storage section 225 is connected to the control section 221 through a system bus 226. Incidentally, the display information generating section 222, the electronic pen indication input detecting section 223, and the color selecting section 224 can also be configured as a software functional section implemented by execution of a program by the control section 221.

The electronic pen indication input detecting section 223 calculates the coordinate values of a position indicated by the pen tip portion of the core body 12 of the electronic pen 1 in an X-axis direction and a Y-axis direction, in reference to a digital signal of a resonance frequency component from the position detecting circuit 206, that is, each of the levels of voltage values of induced voltages generated in the respective loop coils. Further, the electronic pen indication input detecting section 223 sends the calculated coordinate values of the indicated position or time series data regarding the coordinate values to the display information generating section 222.

In addition, the electronic pen indication input detecting section 223 calculates a pressure value from pressure detection output from the pressure detecting circuit 207, and sends the information regarding the pressure value as additional information regarding the coordinate values or the time series data regarding the coordinate values to the display information generating section 222. Further, the electronic pen indication input detecting section 223 detects that the side switch 17 is turned on from detection output from the side switch state detecting circuit 208.

Moreover, though not illustrated in FIG. 1, the tablet device 2 according to the present embodiment displays a menu bar on, for example, an upper part of a display screen of the flat display 21. The menu bar includes a plurality of icons for starting various processing functions, the plurality of icons being a writing icon for starting a writing input mode, a drawing icon for starting a drawing input mode, a color selection icon for starting a color selection mode, and the like. The positions of the menu bar and the respective icons in the menu bar on the display screen, that is, the positions of the menu bar and the respective icons in the menu bar within the detection region of the position detecting sensor 22, are determined in advance. The electronic pen indication input detecting section 223 stores these positions in association with the processing function modes.

When the position indicated by the pen tip portion of the core body 12 of the electronic pen 1 which is calculated in reference to the output of the position detecting circuit 206 is within the range of one icon in the menu bar and selects and indicates the icon and an on operation of the side switch 17 is detected, the electronic pen indication input detecting section 223 sends information regarding which icon is the selected and indicated icon to the control section 221. In response to this, the control section 221 performs control to start a processing function mode corresponding to the selected and indicated icon.

When the started processing function mode is the writing input mode or the drawing input mode, the electronic pen indication input detecting section 223 under control of the control section 221 treats the information regarding the indicated position calculated from the output of the position detecting circuit 206 and the pressure value calculated from the output of the pressure detecting circuit 207 as information regarding the writing trace or the drawing trace, and sends the information regarding the writing trace or the drawing trace to the display information generating section 222.

In addition, when the started processing function mode is the color selection mode, the electronic pen indication input detecting section 223 under control of the control section 221 treats the information regarding the indicated position calculated from the output of the position detecting circuit 206 and the pressure value calculated from the output of the pressure detecting circuit 207 as information for color selection, as will be described later, and sends the information for color selection to the color selecting section 224. Incidentally, in this color selection mode, the electronic pen indication input detecting section 223 sends the information regarding the indicated position calculated from the output of the position detecting circuit 206 also to the display information generating section 222 for display processing in the color selection mode.

When the processing function mode is the writing input mode or the drawing input mode, the display information generating section 222 generates the display information regarding the writing trace or the drawing trace from the information regarding the indicated position and the information regarding the pressure value, these pieces of information being sent from the electronic pen indication input detecting section 223, and the display information generating section 222 supplies the generated display information to the display section 210. The display section 210 displays the display information regarding the writing trace or the drawing trace at the position indicated and input by the electronic pen 1 on the display screen of the flat display 21.

When the processing function mode is the color selection mode, the display information generating section 222 generates display information for the color selection mode, which will be described later, for the flat display 21, and displays the display information on the display screen of the flat display 21 through the display section 210. In addition, also in this color selection mode, the display information generating section 222 performs also the processing of generating the display information regarding the writing trace or the drawing trace from the information regarding the position indicated by the pen tip portion of the core body 12 of the electronic pen 1 and the information regarding the pressure value, and supplying the generated display information to the display section 210.

The color selecting section 224 is controlled by the control section 221 to start operation when the color selection mode is started. In the present embodiment, the color selecting section 224 detects motion of the pen tip portion of the core body 12 of the electronic pen 1 in reference to the information regarding the indicated position calculated from the output of the position detecting circuit 206 in the electronic pen indication input detecting section 223 and the pressure value calculated in the pressure detecting circuit 207, and makes a color selection by referring to color selection table information stored in the color selection table information storage section 225, by using information regarding the detected motion of the pen tip portion of the core body 12 of the electronic pen 1.

The color selection table information stored in the color selection table information storage section 225 in the present embodiment includes hue selection table information, saturation selection table information, and lightness selection table information. The hue selection table information, the saturation selection table information, and the lightness selection table information are pieces of information that associate information regarding each of motions of the pen tip portion of the core body 12 of the electronic pen 1 which are different from each other with each of hue information, saturation information, and lightness information.

In the present embodiment, an operation of circular motion of the position indicated by the pen tip portion of the core body 12 of the electronic pen 1 on the position detecting sensor 22 is assigned a hue selecting operation. In the following, the position indicated by the pen tip portion of the core body 12 of the electronic pen 1 on the position detecting sensor 22 will be abbreviated to the position indicated by the electronic pen 1. The hue selection table information is the information concerning a correspondence table between the information regarding angular range positions different from each other on a circumference in the circular motion operation of the position indicated by the electronic pen 1 and the information regarding hues different from each other which correspond to the respective angular range positions. In the present embodiment, a user can select a hue corresponding to a predetermined angular range position by moving the position indicated by the electronic pen 1 in such a manner as to effect a circular motion thereof and indicating the angular range position.

In addition, in the present embodiment, an operation of rectilinear motion of the position indicated by the electronic pen 1 is assigned a saturation selecting operation. The saturation selection table information is the information concerning a correspondence table between the information regarding positional ranges different from each other on a straight line in the rectilinear motion operation of the position indicated by the electronic pen 1 and the information regarding saturation values different from each other which correspond to the respective positional ranges on the straight line. In the present embodiment, the user can select a saturation corresponding to a positional range on a straight line of rectilinear motion by moving the position indicated by the electronic pen 1, to effect the rectilinear motion thereof, and indicating the positional range on the straight line of the rectilinear motion.

In addition, in the present embodiment, an operation of applying a pressure to the pen tip portion of the core body 12 of the electronic pen 1 (applying a pen pressure) is assigned a lightness selecting operation. In the following, the pressure applied to the pen tip portion of the core body 12 of the electronic pen 1 will be abbreviated to the pressure applied to the electronic pen 1. The lightness selection table information is the information concerning a correspondence table between ranges of values of the pressure applied to the electronic pen 1 which are different from each other (pressure value ranges) and the information regarding lightness values different from each other which correspond to the respective pressure value ranges. In the present embodiment, the user can select lightness different from other lightness by performing an operation of displacing the electronic pen 1 to change the pressure applied to the electronic pen 1.

In this case, the operation in which the user applies a pressure to the pen tip portion of the core body 12 of the electronic pen 1 on the flat display 21 of the tablet device 2 is an operation of depressing and moving a distal end portion of the core body 12 of the electronic pen 1 in a direction intersecting the display screen of the flat display 21, or a direction orthogonal to the display screen of the flat display 21 in the present example. As a result of the operation of applying a pressure to the pen tip portion of the core body 12 of the electronic pen 1, the distal end portion of the core body 12 of the electronic pen 1 produces motion in a direction intersecting (orthogonal to) the display screen of the flat display 21 on which the rectilinear motion operation at a time of saturation selection is performed. According to the motion, the pressure can be detected in the pressure detector 13. That is, the pressure detected according to the operation of pressing the pen tip portion of the core body 12 of the electronic pen 1 against the display screen of the flat display 21 is an example of a displacement quantity based on the motion of the electronic pen 1 in the direction intersecting a plane in which the rectilinear motion operation of the electronic pen 1 is performed to select a saturation.

As described above, in the present embodiment, a color selection is made by selecting each of a hue, a saturation, and a lightness according to different motions of the pen tip portion of the core body 12 of the electronic pen 1.

The hue selection table information, the saturation selection table information, and the lightness selection table information constituting a color selection table stored in the color selection table information storage section 225 are pieces of information for obtaining a hue, a saturation value, and a lightness value corresponding to the above-described respective different motions of the pen tip portion of the core body 12 of the electronic pen 1.

Moreover, in the present embodiment, the display information generating section 222 is configured to, when the color selection mode is started, as illustrated in FIG. 1, set a display region on the left side of the part of a dotted line 22L as a color selection mode region 22CSA on the display screen of the flat display 21, and display a color selection guide figure GCr and a color confirmation region ACr for confirmation display of a selected color in the color selection mode region 22CSA.

The color selection guide figure GCr includes a circular arc figure Cg for hue selection and a Cone figure Tg formed in such a manner as to circumscribe the circular arc figure Cg. In the present example, the circular arc figure Cg for hue selection makes color display of hues assigned to respective angular positions in the circumferential direction of the circular arc figure Cg, and makes display such that saturation changes in the radial direction of the circular arc figure Cg. Moreover, the Cone figure Tg makes display such that lightness changes between the bottom surface and the vertex of the Cone figure Tg.

Moreover, in the present embodiment, as illustrated in FIG. 1, in the color selection mode, the user can select a hue by moving the pen tip portion of the core body 12 of the electronic pen 1 along the circumferential direction of the circular arc figure Cg in such a manner as to effect a circular motion thereof, and performing an indicating operation. Further, the position of the hue being selected is indicated by a mark MKh on the circumference of the circular arc figure Cg, and the hue being selected is reflected in the color confirmation region ACr. Incidentally, in this case, because the hues are assigned to the respective angular range positions different from each other, an operation does not necessarily need to be performed to trace the circumference of the circular arc figure Cg, and a circular motion may be performed at any radial position in the circular arc figure Cg.

In addition, in the present embodiment, the user can select a saturation by making the pen tip portion of the core body 12 of the electronic pen 1 perform rectilinear motion (linear movement) in the radial direction of the circular arc figure Cg, and performing an indicating operation. Further, the position of the saturation being selected is indicated by a mark MKs on a straight line in the radial direction of the circular arc figure Cg, and the saturation being selected is reflected in the color confirmation region ACr. In this case, because the saturation of the hue indicated by the mark MKh on the circumference of the circular arc figure Cg is selected, the mark MKs for the saturation is displayed on a straight line connecting the mark MKh on the circumference of the circular arc figure Cg and the central position of the circular arc figure Cg to each other. Hence, when the hue is changed and the position of the mark MKh for the hue is thereby changed, the position of the straight line on which the mark MKs for the saturation is displayed also moves accordingly.

Further, in the present embodiment, the user can select a lightness by performing an operation to apply a pressure to the pen tip portion of the core body 12 of the electronic pen 1 within the circle of the circular arc figure Cg. Further, the position of the lightness being selected is indicated by a mark MKv on a straight line connecting the vertex of the Cone figure Tg of the color selection guide figure GCr and the central position of the circular arc figure Cg to each other (see a dotted line Tv in FIG. 1), and the lightness being selected is reflected in the color confirmation region ACr. In this case, because the hue indicated by the mark MKh on the circumference of the circular arc figure Cg and the saturation indicated by the mark MKs on the straight line in the radial direction of the circumference of the circular arc figure Cg are being selected, the lightness at the hue and the saturation being selected changes according to the application of the pressure, and the result is displayed in the color confirmation region ACr.

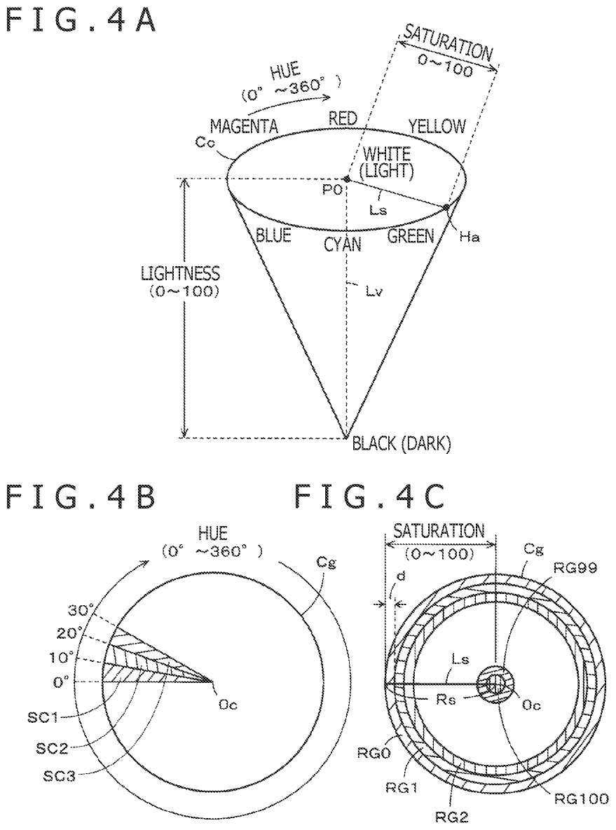

The color selection table information storage section 225 of the information processing circuit 220 stores the color selection table information for selecting the hue, the saturation, and the lightness by the above-described motions of the pen tip portion of the core body 12 of the electronic pen 1 according to operations performed by the user. FIG. 4A is a diagram of assistance in explaining the hue selection table information, the saturation selection table information, and the lightness selection table information constituting the color selection table information in the present embodiment.

As for the hue selection table information included in the color selection table information, in the present embodiment, as illustrated in FIG. 4A, a desired angular position on a circumference Cc (which is a circumference of a perfect circle, though illustrated as an ellipse in FIG. 4A for the convenience of description) is set as a starting point, and with the starting point as 0 degrees, hues different from each other in a red-green-blue (RGB) color space are assigned in order of red→yellow→green→cyan→blue→magenta→red, for example, to respective angular range positions at intervals of, for example, 10 degrees from 0 to 360 degrees. The hue selection table information is correspondence table information between the assigned angular range positions and the respective hues. That is, in the present embodiment, the hues are assigned to the respective angular range positions of a predetermined size.

In this case, in the present first embodiment, a color selecting operation is performed in the color selection guide figure GCr displayed at a determined position of the display screen of the flat display 21. Thus, the circumference Cc coincides with the circular arc figure Cg in FIG. 1, and the angular range positions are sectorial regions SC1, SC2, SC3, . . . obtained by equally dividing a circle enclosed by the circular arc figure Cg in a circumferential direction at intervals of 10 degrees in the present example, as illustrated in FIG. 4B.

The position detecting sensor 22 is disposed under the display screen of the flat display 21. Hence, whether or not the distal end portion of the core body 12 of the electronic pen 1 indicates the inside of each of the sectorial regions SC1, SC2, SC3, . . . can be detected.

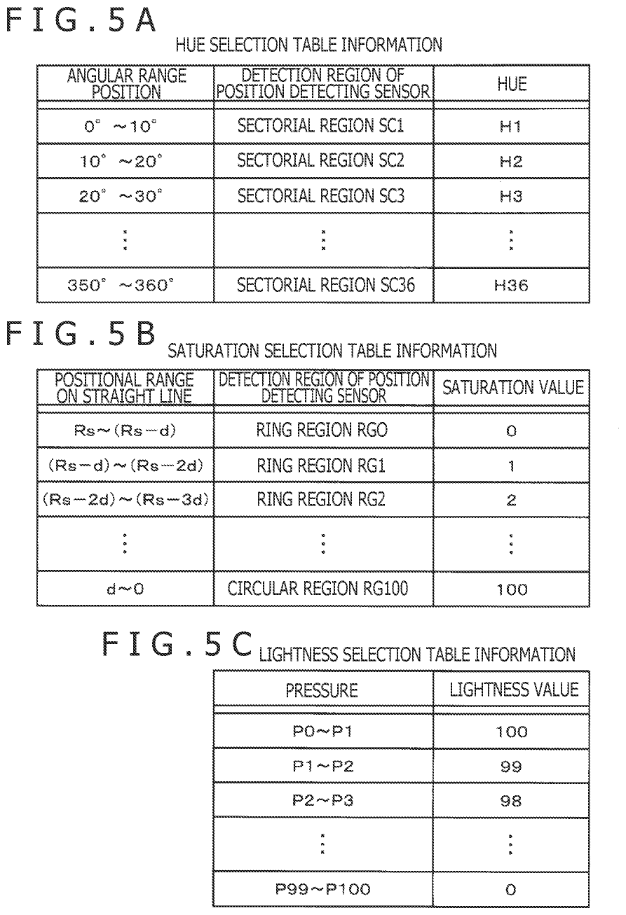

Accordingly, in the present embodiment, as illustrated in FIG. 5A, for example, the hue selection table information is correspondence table information between each of the detection region ranges of sectorial regions in the position detecting sensor 22, which correspond to the sectorial region SC1 of an angular range equal to or more than 0 degrees but less than 10 degrees, the sectorial region SC2 of an angular range equal to or more than 10 degrees and less than 20 degrees, the sectorial region SC3 of an angular range equal to or more than 20 degrees and less than 30 degrees, . . . , and respective corresponding hues H1, H2, H3, . . . .

The color selecting section 224 in the information processing circuit 220 detects which sectorial region among the sectorial regions SC1, SC2, SC3, . . . includes the position indicated by the electronic pen 1, and identifies a selected hue by obtaining the hue corresponding to the detected sectorial region from the hue selection table information stored in the color selection table information storage section 225.

Incidentally, in the present example, the color space is the RGB color space. However, another color space may be used. In addition, the angular positions are not limited to the intervals of 10 degrees, and may of course be at intervals of less than 10 degrees or more than 10 degrees.

Next, as for the saturation selection table information, in the present embodiment, different saturation values from 0 to 100 are assigned to respective positional ranges of divided sections on a straight line of a predetermined length, the positional ranges being different from each other, when the straight line is divided into a plurality of equal parts, for example, 100 equal parts. The saturation selection table information is correspondence table information between the assigned positional ranges of the respective divided sections on the straight line and the respective saturation values.

In FIG. 4A, a radial straight line Ls extending from a central position Po of the circumference Cc, to which the hues are assigned in the circumferential direction, to the angular position of the hue being selected on the circumference Cc is illustrated as a straight line to which a saturation is to be assigned. The saturation selection table information assigned for the straight line Ls in FIG. 4A is information for selecting a saturation for a hue Ha corresponding to an angular range position on the circumference at which the straight line Ls intersects the circumference Cc. A saturation value for the hue Ha is selected by selection of one of the positions of the respective divided regions when the straight line Ls is divided into 100 equal parts.

Instead of determining a saturation value for each of the hues, one straight line is set, and for the straight line, saturation values can be assigned to different positional ranges on the straight line. Further, saturation can be selected by selection of the respective positions on the straight line.

However, in the present embodiment, a color selecting operation is performed in the color selection guide figure GCr displayed at a determined position of the display screen of the flat display 21, so that a hue, a saturation, and a lightness can be selected by a series of successive operations.

In the present embodiment, as in the case of the hue selection table information described above, the saturation selection table information can also be configured as correspondence table information between saturation values assigned on the straight line and detection regions of the position detecting sensor 22.

Moreover, as described above, the circular arc figure Cg of the color selection guide figure GCr displayed at a determined position of the display screen of the flat display 21 coincides with the circumference Cc in FIG. 4A, and as illustrated in FIG. 4C, the straight line Ls is a straight line of a radius Rs from a center Oc of the circular arc figure Cg. Further, in the present example, positions on the straight line Ls to which the respective saturation values are assigned correspond to respective regions of positional ranges of line segment sections having a unit length d (see FIG. 4C) when the straight line Ls of the radius Rs is divided into 100 equal parts.

Further, in consideration of a fact that a saturation is selected for each of the hues assigned along the circumference of the circular arc figure Cg, in the present example, all straight lines of the radius Rs from the central position Oc of the circular arc figure Cg are set as the straight line Ls, and ring regions RG0, RG1, RG2, . . . , RG99 and a circular region RG100 of a radius d illustrated in FIG. 4C, the ring regions RG0, RG1, RG2, . . . , RG99 and the circular region RG100 being divided by circles of radii that each become shorter by the unit length d, are positional ranges different from each other on each radial straight line with the central position Oc as a center, and correspond to the respective saturation values.

The position detecting sensor 22 disposed under the display screen of the flat display 21 can detect a position detection region occupied by the circular arc figure Cg of the color selection guide figure GCr, and can detect each of the ring regions RG0, RG1, RG2, . . . , RG99 and the circular region RG100 of the radius d which are illustrated in FIG. 4C.

Accordingly, in the present embodiment, as illustrated in FIG. 5B, the saturation selection table information is correspondence table information between each of detection region ranges in the position detecting sensor 22, which respectively correspond to the ring regions RG0, RG1, RG2, . . . , RG99 defined by radii successively decreased by the unit length d and the circular region RG100 of the radius d, and corresponding saturation values from 0 to 100.

The color selecting section 224 in the information processing circuit 220 detects which region among the ring regions RG0, RG1, RG2, . . . , RG99 and the circular region RG100 of the radius d includes the position indicated by the electronic pen 1, and identifies a selected saturation value by obtaining the saturation value corresponding to the detected region from the saturation selection table information stored in the color selection table information storage section 225.

In the present embodiment, a hue can be selected from the position indicated by the electronic pen 1 by referring to the hue selection table information, as described above, and hence, both the hue and the saturation can be selected from the position indicated by the electronic pen 1.

Incidentally, it is needless to say that the number of divisions of the straight line in a case where saturation values are assigned to the respective divided positions in order to generate the saturation selection table information is not limited to 100, and is the number of divisions corresponding to the definition of the values assigned as saturation.

Next, as for the lightness selection table information, in the present embodiment, a range from a minimum value to a maximum value of values of the pressure applied to the distal end portion of the core body 12 of the electronic pen 1 is divided into the number of levels corresponding to the definition of lightness values, or 100 levels in the present example, and the pressure values of the respective levels are assigned to lightness values from 0 to 100. The lightness selection table information is correspondence table information between the assigned pressure values and the respective lightness values from 0 to 100.

In FIG. 4A, a straight line Lv from the central position Po of the circumference Cc to which the hues are assigned, the straight line being in a direction orthogonal to a circular plane including the circumference, is illustrated as a lightness value straight line on which the values of the pressure applied to the distal end portion of the core body 12 of the electronic pen 1 from the minimum value to the maximum value are assigned to the values from 0 to 100. This is to clearly illustrate a relation between lightness, hue, and saturation. The example of FIG. 4A illustrates that the lightness values from 0 to 100 are assigned on the straight line Lv such that the higher the pressure becomes, the more the lightness approaches zero (that is, becomes darker). A lightness is selected by change of the value of the pressure applied to the distal end portion of the core body 12 of the electronic pen 1. Incidentally, a direction of change in the lightness with respect to the pressure may of course be configured such that the higher the pressure, the higher the lightness value.

An example of the lightness selection table information is illustrated in FIG. 5C. In the example of FIG. 5C, the minimum value of the pressure values is P0, and the maximum value of the pressure values is P100. Moreover, each of pressure ranges P0 to P1, P1 to P2, P2 to P3, . . . , P99 to P100 is defined by equal division of a range between the minimum value P0 and the maximum value P100, and the lightness values from 0 to 100 are assigned in such a manner as to correspond to the respective pressure ranges.

### Example of Flow of Color Selecting Operation in Color Selecting Section 224 of Information Processing Circuit 220

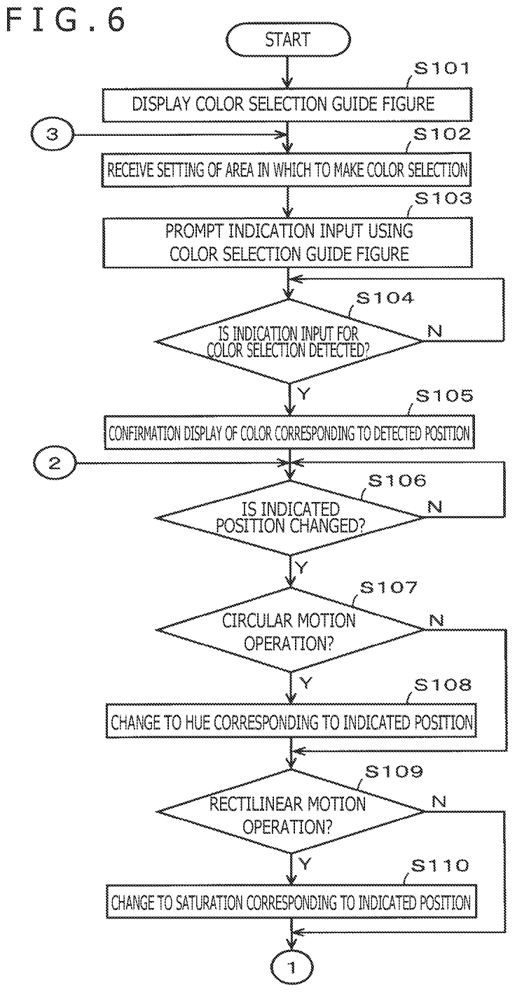

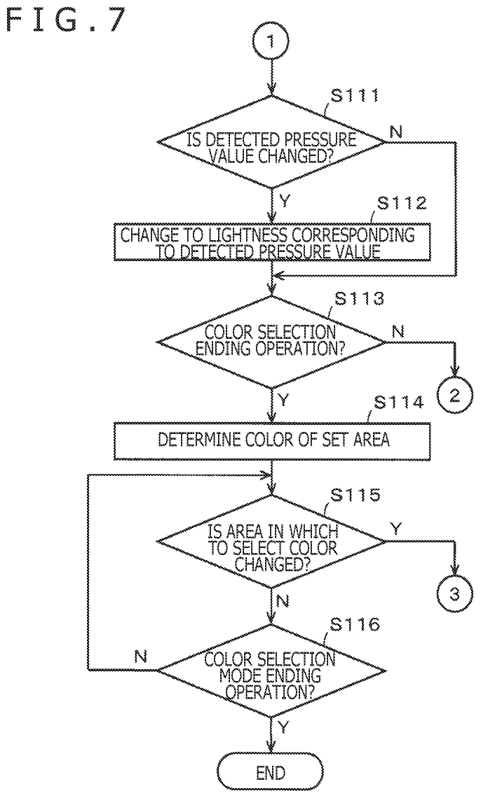

An example of a flow of a color selecting operation in the color selecting section 224 in the information processing circuit 220 configured as described above will be described with reference to a flowchart of FIG. 6 and FIG. 7, with FIG. 7 as a continuation from FIG. 6. Incidentally, the following description will be made of a case where the control section 221 of the information processing circuit 220 implements functions of the display information generating section 222, the electronic pen indication input detecting section 223, and the color selecting section 224 as software function processing using a program.

As described earlier, in the tablet device 2, when the color selection mode is selected by the user, the control section 221 starts operation from a start of FIG. 6, first generates the color selection guide figure GCr and generates the color confirmation region ACr, and displays the color selection guide figure GCr and the color confirmation region ACr in a region on the left side of the display screen of the flat display 21, as illustrated in FIG. 1 (S101).

Next, the control section 221 in the present embodiment notifies the user of a message prompting for designation (setting) of an area (color setting target region) in which to make a color selection, in a display image displayed on the display screen of the flat display 21, and receives a setting of the area in which to make a color selection (S102). For example, in the example illustrated in FIG. 1, a color setting target region Ap is set by the distal end portion of the core body 12 of the electronic pen 1, and hence, the control section 221 receives the setting.

Next, the control section 221 notifies the user of a message prompting color selection indicating operation in the color selection guide figure GCr (S103). Accordingly, the control section 221 monitors whether or not the distal end portion of the core body 12 of the electronic pen 1 is indicating the inside of the color selection guide figure GCr, as illustrated in FIG. 1, and determines whether or not indication input by the electronic pen 1 within the color selection guide figure GCr is detected (S104).

When the control section 221 determines at S104 that indication input by the electronic pen 1 within the color selection guide figure GCr is detected, the control section 221 refers to the hue selection table information and the saturation selection table information, and determines a hue and a saturation corresponding to the position indicated by the electronic pen 1. Further, the control section 221 detects a pressure applied to the distal end portion of the core body 12 of the electronic pen 1 at this time, refers to the lightness selection table information in reference to the detected pressure, determines a lightness corresponding to the detected pressure, and displays a color of the hue, the saturation, and the lightness that have been determined in the color confirmation region ACr (S105). At this time, the color selection guide figure GCr displays the marks MKh, MKs, and MKv at positions corresponding to the hue, the saturation, and the lightness that have been selected.

Next, the control section 221 monitors whether or not the position indicated by the electronic pen 1 is changed (S106). When the control section 221 determines that the position indicated by the electronic pen 1 is changed, the control section 221 first refers to sectorial region information in the hue selection table information included in the color selection table information and determines whether or not a circular motion operation is performed, according to whether or not the position indicated by the electronic pen 1 has moved over to a different sectorial region (S107). When the control section 221 determines at S107 that a circular motion operation is performed, the control section 221 refers to the hue selection table information, changes to a hue corresponding to the sectorial region including the post-change position indicated by the electronic pen 1, and displays the color of the hue in the color confirmation region ACr (S108). At this time, in the color selection guide figure GCr, the display position of the mark MKh for hue is changed according to the change in hue.

Next, the control section 221 refers to the ring regions RG0, RG1, RG2, . . . , RG99 and the circular region RG100 of the radius d in the saturation selection table information included in the color selection table information, and determines whether or not a rectilinear motion operation is performed, according to whether or not the position indicated by the electronic pen 1 has moved over to a different ring region or the circular region (S109). Also when the control section 221 determines at S107 that no circular motion operation is performed, the control section 221 makes the processing jump from S107 to S109, and determines whether or not a rectilinear motion operation is performed.

When the control section 221 determines at S109 that a rectilinear motion operation is performed, the control section 221 refers to the saturation selection table information, changes to a saturation value corresponding to the ring region including the post-change position indicated by the electronic pen 1, and reflects the post-change saturation value in the display color of the color confirmation region ACr (S110). At this time, in the color selection guide figure GCr, the display position of the mark MKs for saturation is changed according to the change in saturation.

Next, the control section 221 determines whether or not a detected pressure value detected by the pressure detecting circuit 207 has changed (S111 in FIG. 7). Also when the control section 221 determines at S109 that no rectilinear motion operation is performed, the control section 221 makes the processing jump from S109 to S111, and determines whether or not the detected pressure value has changed.

Then, when the control section 221 determines at S111 that the detected pressure value has changed, the control section 221 refers to the lightness selection table information, changes to a lightness value corresponding to the post-change detected pressure value, and reflects the lightness value in the display color of the color confirmation region ACr (S112). At this time, in the color selection guide figure GCr, the display position of the mark MKv for lightness is changed according to the change in lightness.

Next, the control section 221 determines whether or not a color selection ending operation in the color setting target region Ap is performed (S113). An example of this color selection ending operation in the present example is a long depressing operation that holds the side switch 17 of the electronic pen 1 in an on state. It is to be noted that the color selection ending operation is not limited to the long depressing operation that holds the side switch 17 in an on state, and may, for example, be an operation of indicating an icon button for the color selection ending operation by the electronic pen 1, the icon button being displayed in the color selection mode region 22CSA, or may be performed by another operating section.

When the control section 221 determines at S113 that the color selection ending operation is not performed, the control section 221 returns the processing to S106, and repeats the processing from S106 on down to receive selections of a hue, a saturation, and a lightness.

In addition, when the control section 221 determines at S113 that the color selection ending operation is performed, the control section 221 determines (selects) a color identified by the hue, the saturation, and the lightness selected thus far, as a color in the color setting target region Ap (S114).

Next, the control section 221 determines whether or not the color setting target region Ap is changed and set (S115). When the control section 221 determines that the color setting target region Ap is changed and set, the control section 221 returns the processing to S102 to receive a setting of a new color setting target region Ap, and repeats the processing from S102 on down.

Then, when the control section 221 determines at S115 that the color setting target region Ap is not changed and set, the control section 221 determines whether or not an operation of ending the color selection mode is performed (S116). When the control section 221 determines that the operation of ending the color selection mode is not performed, the control section 221 returns the processing to S115. In addition, when the control section 221 determines at S116 that the operation of ending the color selection mode is performed, the control section 221 ends the processing of the color selection mode.

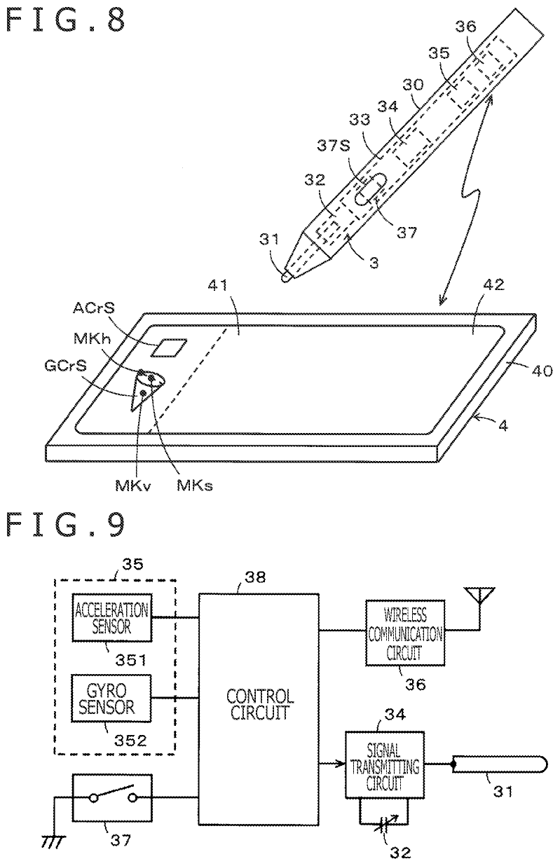

As described above, the color selecting method according to the present first embodiment can make a color selection according to the movements of the position indicated by the electronic pen 1. Moreover, according to the foregoing first embodiment, a desired color can easily be selected by performance of a circular motion operation and a rectilinear motion operation of the position indicated by the electronic pen 1 and performance of an operation of applying a pressure to the core body 12 of the electronic pen 1, that is, by successive movements of the electronic pen 1. Specifically, as illustrated in FIG. 8, for example, a color of a desired hue, a desired saturation, and a desired lightness can easily be determined by a series of successive operations as in selecting the hue by performing a circular motion operation of the position indicated by the electronic pen 1, next selecting the saturation by performing a rectilinear motion operation thereof, and further selecting the lightness by performing an operation of changing the pressure applied to the distal end portion of the core body 12 of the electronic pen 1.

In addition, in the foregoing first embodiment, a specific region of the display screen of the flat display 21 is set as the color selection mode region 22CSA, the color selection guide figure GCr is displayed at a determined position within the color selection mode region 22CSA, and a color selecting operation is performed by position indication by the electronic pen 1 in the color selection guide figure GCr. However, instead of performing a color selecting operation by the electronic pen 1 at the thus fixedly determined position, there may be adopted a configuration in which a figure similar to the color selection guide figure GCr is displayed at any position of the display screen of the flat display 21 to enable a color selecting operation in the color selection mode.

In such a case, the user can perform a color selecting operation while having the color selection guide figure GCr having such a size as to easily be operated by the user displayed at a position at which the operation is easily performed.

In addition, there may be adopted a configuration in which the color selection guide figure GCr within the color selection mode region 22CSA in FIG. 1 is used only for mark display of operation positions at a time of the color selecting operation, and the circular motion operation and the rectilinear motion operation for selecting a hue and a saturation are performed at any position of the display screen of the flat display 21. In that case, the circumference of the circular motion operation and the straight line of the rectilinear motion operation may be displayed in a transparent, semitransparent, or opaque color on the display screen according to indication input by the electronic pen 1.

In such a case, the hue selection table information in the color selection table information stored in the information processing circuit 220 is set by omission of the information regarding the detection regions of the position detecting sensor 22 included in the table information illustrated in FIG. 5A, and is set as correspondence table information between the angular range positions and the hues. In addition, similarly, the saturation selection table information is set by omission of the information regarding the detection regions of the position detecting sensor 22, and is set as correspondence table information between the information regarding the positional ranges on the straight line and the saturation values. In this case, the positional ranges on the straight line in the saturation selection table information are set as respective positional ranges in a predetermined reference length determined in advance.

Then, in selecting a hue, the color selecting section 224 detects each angular range position in a circular shape of a circular motion operation which is described by the electronic pen 1 detected by the electronic pen indication input detecting section 223 according to the output of the position detecting circuit 206, and selects a corresponding hue by referring to the hue selection table information according to the detected angular range position.

In addition, in selecting a saturation, the color selecting section 224 detects a positional range on a straight line of rectilinear motion operation which is described by the electronic pen 1 detected by the electronic pen indication input detecting section 223 according to the output of the position detecting circuit 206. Then, a positional range on the straight line having the reference length which corresponds to the detected positional range is detected, and a corresponding saturation is selected by referring to the saturation selection table information according to the detected positional range on the straight line having the reference length.

Incidentally, also in this case, a lightness is selected by the pressure applied to the distal end portion of the core body 12 of the electronic pen 1.

Moreover, in this case, in the color selection guide figure GCr, the marks MKh and MKs are displayed at the operation positions of a hue selecting operation by the electronic pen 1 and a saturation selecting operation by the electronic pen 1 at a time of the hue selecting operation and at a time of the saturation selecting operation, and the mark MKv for the lightness moves according to the selection of the lightness. The user is thereby informed of the hue, the saturation, and the lightness being selected. In addition, a color of the hue, the saturation, and the lightness being selected at this time is displayed in the color confirmation region ACr.

In this case, while the straight line at the time of selecting the saturation may be the radius of the circumference of the circular motion operation for selecting the hue as in the above-described example, the straight line at the time of selecting the saturation may be a straight line of rectilinear motion operation at any position regardless of the circumference of the circular motion operation. Moreover, in this case, there may be adopted a configuration in which switching between the operations of selecting the hue, the saturation, and the lightness can be performed each time the side switch is turned on, for example, to clarify which of the operations of selecting the hue, the saturation, and the lightness is to be performed.

Incidentally, also in this case, the color selecting section 224 may be configured to calculate in advance sectorial regions corresponding to respective angular range positions in the circular shape of the circular motion operation which is described by the electronic pen 1, and detect each angular range position according to which sectorial region includes the position indicated by the electronic pen 1. Similarly, in a case where the rectilinear motion operation for selecting the saturation is a rectilinear motion operation on the radius of the circumference of the circular motion operation at the time of the hue selection, the color selecting section 224 may be configured to calculate in advance ring regions corresponding to positional ranges on the straight line of the rectilinear motion operation, and detect each positional range on the straight line according to which ring region includes the position indicated by the electronic pen 1.

Incidentally, in the foregoing embodiment, the hue, the saturation, and the lightness are selected successively by a series of successive actions (operations) as movements of the distal end portion of the core body 12 of the electronic pen 1. However, an instruction may be given to switch to the hue selection, the saturation selection, or the lightness selection each time the side switch 17 of the electronic pen 1 is operated to be turned on. For example, a color selecting operation procedure may be determined in order of the hue selection, the saturation selection, and the lightness selection in advance, and switching may be performed in order of the hue selection→the saturation selection→the lightness selection→the hue selection each time the side switch 17 is turned on.

Incidentally, in the description of the foregoing embodiment, the information regarding the pressure detected by the pressure detector 13 of the electronic pen 1 and the on/off state information of the side switch 17 are transmitted as a change in the resonance frequency of the resonance circuit RC to the tablet device 2 through the position detecting sensor 22. However, a configuration may be adopted such that wireless communication sections of a Bluetooth (registered trademark) standard, for example, are included in the electronic pen 1 and the tablet device 2, and these pieces of information are separately transmitted to the tablet device 2 through these wireless communication sections.

In addition, while the electronic pen 1 according to the first embodiment is an electromagnetic induction type electronic pen, the electronic pen 1 may have a configuration of a capacitive type, particularly an active capacitive type. Also in that case, the information regarding the pressure detected by the pressure detector 13 and the on/off state information of the side switch 17 may be transmitted to the tablet device through a capacitive type position detecting sensor together with a position detection signal, or may be transmitted to the tablet device through the wireless communication sections separately from the position detection signal.

In addition, in the foregoing first embodiment, a saturation is selected by the rectilinear motion operation, and a lightness is selected by a change in the pressure applied to the electronic pen 1. However, there may be adopted a configuration in which a saturation is selected by a change in the pressure applied to the electronic pen 1 and a lightness is selected by the linear motion operation.

### Second Embodiment

FIG. 8 is a diagram illustrating an outline of the color selecting apparatus of a second embodiment. The color selecting apparatus according to the second embodiment includes an electronic pen 3 as an example of a position indicator and a tablet device 4 as an example of an information processing device. In the second embodiment, the electronic pen 3 includes a movement detecting sensor (motion sensor) that detects the movement of the electronic pen 3, and has a function of transmitting a movement detection output of the movement detecting sensor as color selecting operation information to the tablet device 4. Moreover, the tablet device 4 is configured to have functions of detecting the movement of the electronic pen 3 in reference to the detection output of the movement detecting sensor which is received from the electronic pen 3, and making a color selection by detecting operations of selecting a hue, a saturation, and a lightness as in the first embodiment according to a result of the movement detection.

The electronic pen 3 in the second embodiment has a configuration of the active capacitive type. The electronic pen 3 has an opening on one end side in the axial direction of a tubular casing 30. One end in the axial direction as a pen tip portion of a rod-shaped core body 31 formed of a conductor, for example, a conductive metal, protrudes through the opening. The pen tip portion of the core body 31 of the electronic pen 3 constitutes a position indicating portion of the electronic pen 3 as an example of a position indicator.

An end portion of the core body 31 which is on an opposite side from the pen tip portion side is fitted to a pressure detector 32 attached in a state of being immovable in the axial direction within the casing 30. The pressure detector 32 has a configuration similar to that of the pressure detector 13 in the first embodiment.

Moreover, a circuit board 33 is provided inside the casing 30 of the electronic pen 3. The circuit board 33 includes a signal transmitting circuit 34, a movement detecting sensor 35, and a wireless communication section 36. In addition, in the present example, the circuit board 33 includes a side switch 37 that has functions similar to those of the side switch 17 of the electronic pen 1 according to the first embodiment. The side switch 37 is turned on and off by a switch operating element 37S provided in such a manner as to be exposed outward from a peripheral side surface of the casing 30.

As illustrated in FIG. 8, the tablet device 4 in the second embodiment has a rectangular casing 40 of a flat and thin type. The tablet device 4 includes a flat display 41 including a liquid crystal display (LCD), for example, inside the casing 40. In addition, a transparent position detecting sensor 42 that performs signal interaction with the electronic pen 3 is provided on the top surface of the flat display 41 in such a manner as to be superposed on the flat display 41. The position detecting sensor 42 includes a capacitive type position detecting sensor. Moreover, a circuit board not illustrated is provided on the undersurface side of the flat display 41 inside the casing 40 of the tablet device 4.

### Example of Electric Configuration of Electronic Pen 3

FIG. 9 is a block diagram illustrating an example of an electric configuration of the electronic pen 3 according to the second embodiment. As illustrated in FIG. 9, the electronic pen 3 includes a control circuit 38 including a computer (microprocessor), and is configured such that each of the signal transmitting circuit 34, the movement detecting sensor 35, the wireless communication section 36, and the side switch 37 is connected to the control circuit 38.

Under control of the control circuit 38, the signal transmitting circuit 34 outputs a transmission signal of a predetermined frequency as a position detection signal. The transmission signal from the signal transmitting circuit 34 is supplied to the core body 31 as a conductor, and is transmitted by capacitive coupling to the position detecting sensor 42 of the tablet device 4.

The movement detecting sensor 35 in the present embodiment includes an acceleration sensor 351 and a gyro sensor 352. In the case of the present example, the acceleration sensor 351 and the gyro sensor 352 have a configuration of a multi-axis sensor such as a two-axis or three-axis sensor, and is configured to be able to detect movements of the electronic pen 3 in an X-axis direction, a Y-axis direction, and a Z-axis direction orthogonal to each other. Detection outputs of the acceleration sensor 351 and the gyro sensor 352 are supplied to the control circuit 38.

In addition, the side switch 37 is also connected to the control circuit 38. The control circuit 38 is configured to be able to detect the on/off state of the side switch 37.

Moreover, the control circuit 38 is connected with the wireless communication section 36. This wireless communication section 36 includes a short-range wireless communication section of the Bluetooth (registered trademark) standard, for example. In the present embodiment, the control circuit 38 is configured to transmit the detection outputs of the acceleration sensor 351 and the gyro sensor 352 of the movement detecting sensor 35 and the on/off state detection output of the side switch 37 to the tablet device 4 through the wireless communication section 36.

Incidentally, though not illustrated, the electronic pen 3 includes, as a power supply, a fixed cell or a rechargeable battery (including a cell, an electric double layer capacitor, and the like).

### Example of Electric Configuration of Tablet Device 4

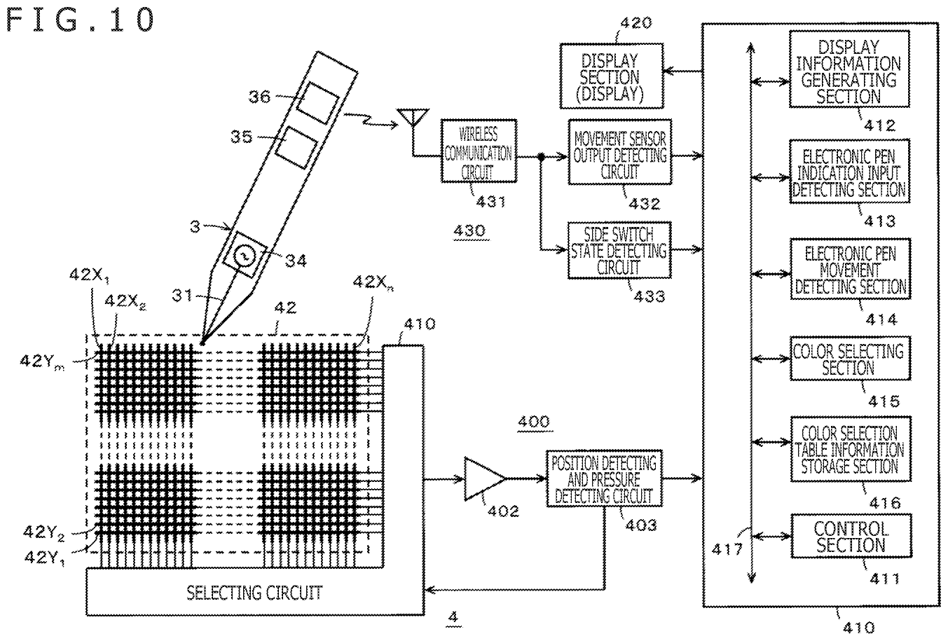

FIG. 10 is a block diagram of an example of an electric configuration formed on the circuit board of the tablet device 4 according to the second embodiment. As illustrated in FIG. 10, the tablet device 4 in the present example includes the position detecting sensor 42, a sensor signal processing circuit 400 connected to the position detecting sensor 42, an information processing circuit 410, a display section 420, and a radio signal processing circuit 430.

The position detecting sensor 42 in the present example includes a Y-axis direction conductor group in which a plurality of first conductors (Y-axis direction conductors) 42Y₁, 42Y₂, . . . , 42Yₘ (m is an integer of 1 or more) extending in the horizontal direction (X-axis direction) of the flat display 41 are arranged in parallel with each other in such a manner as to be separated from each other at predetermined intervals in the vertical direction (Y-axis direction) of the flat display 41 and an X-axis direction conductor group in which a plurality of second conductors (X-axis direction conductors) 42X₁, 42X₂, . . . , 42Xₙ (n is an integer of 1 or more) extending in the vertical direction (Y-axis direction) are arranged in parallel with each other in such a manner as to be separated from each other at predetermined intervals in the X-axis direction. In the following description, when the plurality of Y-axis direction conductors of the Y-axis direction conductor group and the plurality of X-axis direction conductors of the X-axis direction conductor group do not need to be distinguished from one another, the plurality of Y-axis direction conductors and the plurality of X-axis direction conductors will respectively be referred to as Y-axis direction conductors 42Y and X-axis direction conductors 42X.

The sensor signal processing circuit 400 performs signal interaction with the electronic pen 3 by capacitive coupling through the position detecting sensor 42. The sensor signal processing circuit 400 thereby detects a position indicated by the electronic pen 3 in the detection region of the position detecting sensor 42 and, in the present example, detects a pressure applied to a distal end portion of the core body 31 of the electronic pen 3.

In the example of FIG. 10, the sensor signal processing circuit 400 includes a selecting circuit 401 as an input-output interface with the position detecting sensor 42, an amplifier circuit 402, and a position detecting and pressure detecting circuit 403.

The position detecting and pressure detecting circuit 403 includes a control section not illustrated. The selecting circuit 401 selects one Y-axis direction conductor 42Y or one X-axis direction conductor 42X from the Y-axis direction conductor group and the X-axis direction conductor group in reference to a control signal from the control section of the position detecting and pressure detecting circuit 403. The conductor selected by the selecting circuit 401 is connected to the amplifier circuit 402. A signal from the electronic pen 3 is detected by the selected conductor, and is amplified by the amplifier circuit 402. An output of the amplifier circuit 402 is supplied to the position detecting and pressure detecting circuit 403.

According to the output of the amplifier circuit 402, the position detecting and pressure detecting circuit 403 calculates the coordinates of a position on the position detecting sensor 42 which is indicated by the electronic pen 3, by determining which conductor has detected the signal from the electronic pen 3, and detects a pressure applied to the distal end portion of the core body 31 of the electronic pen 3 by detecting a change in the frequency of the signal from the electronic pen 3. Further, the position detecting and pressure detecting circuit 403 supplies the detected coordinate information regarding the position indicated by the electronic pen and the information regarding the detected pressure to the information processing circuit 410.

In the second embodiment, as described above, the sensor output of the movement detecting sensor 35 provided in the electronic pen 3 and the on/off state information of the side switch 37 are sent to the radio signal processing circuit 430 through the wireless communication section 36 of the electronic pen 3. Thus, the radio signal processing circuit 430 receives a radio signal from the electronic pen 3, and detects the sensor output of the movement detecting sensor 35 and the side switch state information, the sensor output and the side switch state information being included in the radio signal.

Specifically, the radio signal processing circuit 430 includes a wireless communication section 431 for performing wireless communication with the wireless communication section 36 of the electronic pen 3. The received signal as the radio signal from the electronic pen 3 which is received by the wireless communication section 431 is supplied to a movement detecting sensor output detecting circuit 432 and a side switch state detecting circuit 433. Then, the movement detecting sensor output detecting circuit 432 detects the sensor output of the acceleration sensor 351 of the electronic pen 3 and the sensor output of the gyro sensor 352 of the electronic pen 3 from the received signal, and supplies the sensor outputs to the information processing circuit 410. In addition, the side switch state detecting circuit 433 detects the on/off state information of the side switch 37 of the electronic pen 3 from the received signal, and supplies the on/off state information to the information processing circuit 410.

In the information processing circuit 410, a control section 411 is connected with each of a display information generating section 412, an electronic pen indication input detecting section 413, an electronic pen movement detecting section 414, a color selecting section 415, and a color selection table information storage section 416 through a system bus 417. Incidentally, the display information generating section 412, the electronic pen indication input detecting section 413, the electronic pen movement detecting section 414, and the color selecting section 415 can also be configured as software functional sections implemented by execution of a program by the control section 411.

Though not illustrated, as with the tablet device 2 according to the first embodiment, the tablet device 4 according to the second embodiment also displays a menu bar on a display screen of the flat display 41, for example. The tablet device 4 is configured such that, according to an operating instruction using the electronic pen 3, the writing input mode or the drawing input mode is selected and started through the menu bar, and the color selection mode is selected and started through the menu bar.

Under control of the control section 411, the display information generating section 412 generates display information according to the started mode such as the writing input mode, the drawing input mode, or the color selection mode, and supplies the generated display information to the display section 420 to display the display information on the display screen of the flat display 41.

The electronic pen indication input detecting section 413 in the second embodiment performs operation other than the operation of the electronic pen indication input detecting section 223 in the first embodiment in the color selection mode. In the second embodiment, detection processing for the movement of the electronic pen 3 which is related to color selection in the color selection mode is performed by the electronic pen movement detecting section 414.

Specifically, when the position indicated by the pen tip portion of the core body 31 of the electronic pen 3 which is detected by the position detecting and pressure detecting circuit 403 is within the range of one icon in the menu bar and selects and indicates the icon and an on operation of the side switch 37 is detected, the electronic pen indication input detecting section 413 sends information regarding which icon is the selected and indicated icon to the control section 411. In response to this, the control section 411 performs control to start a processing function mode corresponding to the selected and indicated icon.

Further, when the started processing function mode is the writing input mode or the drawing input mode, the electronic pen indication input detecting section 413 under control of the control section 411 sends the information regarding the indicated position and the pressure value calculated from the output of the position detecting and pressure detecting circuit 403 as information regarding a writing trace or a drawing trace to the display information generating section 412.

When the processing function mode is the writing input mode or the drawing input mode, the display information generating section 412 generates display information regarding the writing trace or the drawing trace of the electronic pen 3 from the information regarding the position indicated by the electronic pen 3 and the pressure value, which is received from the electronic pen indication input detecting section 413, and supplies the display information regarding the writing trace or the drawing trace to the display section 420 to display the display information on the flat display 41.

When the started processing function mode is the color selection mode, the control section 411 starts the operation of the electronic pen movement detecting section 414. The electronic pen movement detecting section 414 in the second embodiment receives the sensor output of the acceleration sensor 351 and the sensor output of the gyro sensor 352 from the movement detecting sensor output detecting circuit 432 and the side switch state information from the side switch state detecting circuit 433, detects a movement of the electronic pen 3 from these pieces of information, and sends a resulting movement detection output and the side switch state information to the color selecting section 415.

The color selecting section 415 determines operation related to a color selection, as described later in detail, from the movement detection output and the side switch state information from the electronic pen movement detecting section 414, and performs a color selecting operation by referring to the color selection table information stored in the color selection table information storage section 416.

Under control of the control section 411, also in the second embodiment, as illustrated in FIG. 8, when the processing function mode is the color selection mode, the display information generating section 412 displays a color selection guide figure GCrS and a color confirmation region ACrS for confirmation display of a selected color in a display region on the left side of the display screen of the flat display 41.

As with the color selection guide figure GCr according to the first embodiment, the color selection guide figure GCrS makes color display of hues in a circular arc figure, the hues being assigned to respective angular positions in the circumferential direction of the circular arc figure, and makes display such that the saturation changes in the radial direction of the circular arc figure. Moreover, a Cone figure makes display such that the lightness changes between the bottom surface and the vertex of the Cone figure.

In the second embodiment, the color selection guide figure GCrS is not used for color selecting operation, and is configured to be used as an aid at a time of a color selection by the user, by displaying the selected positions of a hue, a saturation, and a lightness selected by operations for color selection performed according to the sensor output of the movement detecting sensor 35 of the electronic pen 3, which will be described later, by marks MKh, MKs, and MKv in the color selection guide figure GCrS. The color confirmation region ACrS has a configuration similar to that of the color confirmation region ACr in the first embodiment, and performs operations and roles similar to those of the color confirmation region ACr.

### Example of Color Selecting Method in Second Embodiment

The first embodiment detects a circular motion operation and a rectilinear motion operation from movements of the position indicated by the distal end portion of the core body 12 of the electronic pen 1, and makes a color selection by using a result of the detection. On the other hand, the second embodiment detects movements of the electronic pen 3 in a three-dimensional space above the tablet device 4, for example, by using the sensor output of the movement detecting sensor 35 provided inside the casing 30 of the electronic pen 3 instead of detecting, as movements, changes in the position indicated by the electronic pen 3 in the position detection region of the movement detecting sensor 35, and makes a color selection by using a result of the movement detection. In this case, movements of the part of the movement detecting sensor 35 inside the casing are detected as the movements of the electronic pen 3.

In this case, also in the second embodiment, a hue is selected in reference to a circular motion operation of the electronic pen 3, and a saturation is selected in reference to a rectilinear motion operation of the electronic pen 3. However, while the circular motion operation and the rectilinear motion operation in this case may be performed on a two-dimensional plane on the display screen of the flat display 41 of the tablet device 4, not only motion operations on the two-dimensional plane on the display screen but also motion operations in a three-dimensional space above the display screen of the flat display 41 are possible as the circular motion operation and the rectilinear motion operation in this case.

Moreover, in the second embodiment, a lightness is selected according to a rectilinear motion operation in a spatially different direction from that of the rectilinear motion operation at a time of selecting the saturation in place of the pressure applied to the distal end portion of the core body 31 of the electronic pen 3. Specifically, when supposing a plane including a straight line for spatially selecting the saturation, a rectilinear motion operation in a plane in a direction intersecting the plane, or a direction orthogonal to the plane in the present example, which intersects (for example, in a direction orthogonal to) the rectilinear motion operation for the saturation, is used as the rectilinear motion operation for selecting the lightness.

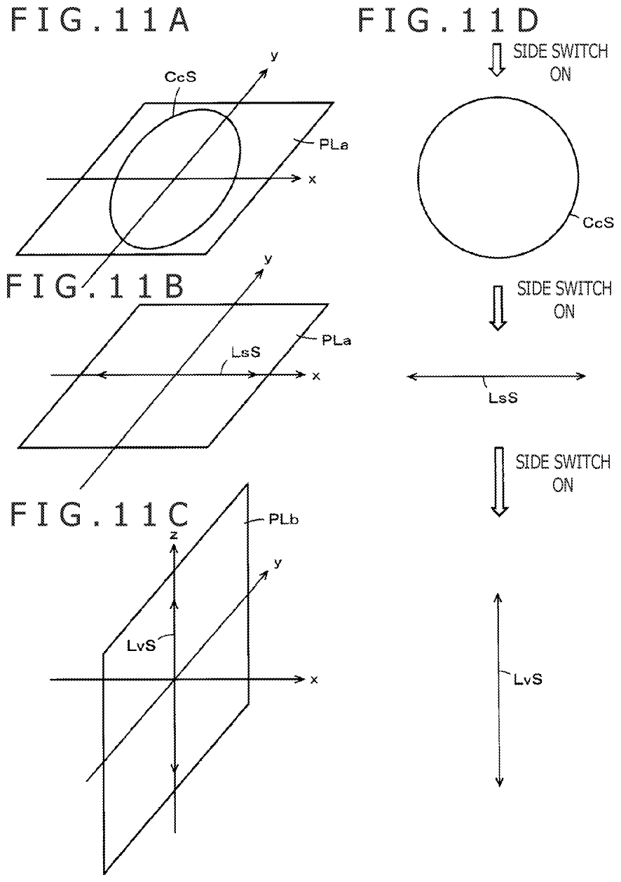

For example, in the second embodiment, in a three-dimensional space defined by an X-axis, a Y-axis, and a Z-axis orthogonal to one another, a plane including a circumference CcS of the circular motion operation for selecting the hue is set as a plane PLa defined by the X-axis and the Y-axis, as illustrated in FIG. 11A. Moreover, the rectilinear motion operation for selecting the saturation is performed along a straight line LsS within the plane PLa, as illustrated in FIG. 11B. Further, a rectilinear motion operation for selecting the lightness is performed along a straight line LvS in a direction intersecting the straight line LsS or, for example, orthogonal to the straight line LsS, within a plane PLb including the Z-axis orthogonal to the plane PLa, as illustrated in FIG. 11C. The plane PLa in the present example is, for example, a plane parallel with the display screen of the flat display 41 of the tablet device 4. Hence, in the present example, the rectilinear motion operation for selecting the saturation is within the plane parallel with the display screen of the flat display 41, and the rectilinear motion operation for selecting the lightness is orthogonal to the straight line LsS and within the plane orthogonal to the display screen of the flat display 41.

That is, in the case of the present example, a rectilinear motion operation performed while a position at which the user holds the electronic pen 3 is constantly maintained in a state of being at the same distance from the display screen is a saturation selecting operation. In addition, a rectilinear motion operation as a vertical movement performed to change the distance between the position at which the user holds the electronic pen 3 and the display screen is a lightness selecting operation.

It is to be noted that, while the plane PLa in which the rectilinear motion operation for selecting the saturation is performed is a plane including the circumference CcS of the circular motion operation for selecting the hue in the example illustrated in FIG. 11A, the plane PLa in which the rectilinear motion operation for selecting the saturation is performed may be unrelated to the plane including the circumference CcS of the circular motion operation for selecting the hue. In short, it suffices for the straight line LsS and the straight line LvS to be formed in directions intersecting each other, or directions orthogonal to each other in the present example.

As in the first embodiment, the color selection table information storage section 416 stores hue selection table information, saturation selection table information, and lightness selection table information. However, the hue selection table information, the saturation selection table information, and the lightness selection table information stored in the color selection table information storage section 416 in the second embodiment are different from those stored in the first embodiment which are illustrated in FIGS. 5A to 5C.

That is, the hue selection table information in the color selection table information stored in the information processing circuit 410 in the second embodiment is set by omission of the information regarding the detection regions of the position detecting sensor 42 in the table information illustrated in FIG. 5A, and is set as correspondence table information between the angular range positions and the hues. In addition, similarly, the saturation selection table information is set by omission of the information regarding the detection regions of the position detecting sensor 42, and is set as correspondence table information between the information regarding each positional range on a straight line having a predetermined reference length determined in advance and the saturation values. Moreover, though not illustrated, the lightness selection table information is set as correspondence table information between the information of each positional range when a straight line having a predetermined reference length determined in advance is divided into 100 parts, for example, and the lightness values.

In the second embodiment, in order that the hue selection table information, the saturation selection table information, and the lightness selection table information included in the color selection table information can easily be referred to from movements in the three-dimensional space in making a color selection, the user, for example, first performs a reference standard circular motion operation and reference standard rectilinear motion operations to be used as reference standards at times of selecting a hue, a saturation, and a lightness by the electronic pen 3 in the three-dimensional space above the display screen of the flat display 41 of the tablet device 4. The color selection guide figure GCrS illustrated in FIG. 8 is displayed by performance of the reference standard circular motion operation and the reference standard rectilinear motion operations, and a hue, a saturation, and a lightness are affixed thereto. The user can confirm a part being selected while viewing this color arrangement. A hue, a saturation, and a lightness are selected and determined while the color selection guide figure GCrS illustrated in FIG. 8 is viewed.

In the present example, the user performs a reference standard circular motion operation by performing a circular motion operation on a plane parallel with the display screen of the flat display 41 of the tablet device 4, and similarly performs a reference standard rectilinear motion operation for saturation selection by performing a rectilinear motion operation on a plane parallel with the display screen of the flat display 41. Further, the user performs a reference standard rectilinear motion operation for lightness selection by performing a rectilinear motion operation on a plane orthogonal to the display screen of the flat display 41.

Next, the user performs a color selecting operation by operating the electronic pen 3 in such a manner as to change a hue by changing an angular positional range in the circumferential direction defined by the reference standard circular motion operation, operating the electronic pen 3 in such a manner as to change a saturation by changing a positional range on a straight line defined by the reference standard rectilinear motion operation for saturation selection, and operating the electronic pen 3 in such a manner as to change a lightness by changing a positional range on a straight line defined by the reference standard rectilinear motion operation for lightness selection.

Incidentally, in the second embodiment, in order to clearly convey the operations of selecting a hue, a saturation, and a lightness to the tablet device 4, as illustrated in FIG. 11D, the side switch 37 of the electronic pen 3 is turned on before movements for selecting the hue by a circular motion operation, selecting the saturation by a rectilinear motion operation, and selecting the lightness by a rectilinear motion operation are each performed. Moreover, in the present example, for example, switching in order of the hue→the saturation→the lightness is enabled, and a return is made to the hue when the side switch 37 is turned on at a time of lightness selection. Thus, the switching is allowed to be performed cyclically and sequentially.

The information processing circuit 410 of the tablet device 4 performs the following processing operation according to the movement operations of the electronic pen 3 by the user in the color selection mode described above.

Specifically, the color selecting section 415 of the information processing circuit 410 generates reference information for obtaining a hue, a saturation value, and a lightness value by referring to the hue selection table information, the saturation selection table information, and the lightness selection table information according to the reference standard circular motion operation and the reference standard rectilinear motion operations.

Hue reference information for referring to the hue selection table information is the length of an arc on the circumference of the reference standard circular motion operation which corresponds to one angular range in the hue selection table information (which will hereinafter be referred to as a hue change unit arc length). The color selecting section 415 detects the circumferential length of the reference standard circular motion operation from the sensor outputs of the acceleration sensor 351 and the gyro sensor 352 with regard to the reference standard circular motion operation of the electronic pen 3 in the three-dimensional space which is detected by the electronic pen movement detecting section 414, and in the present example, the color selecting section 415 calculates the hue change unit arc length corresponding to an angular range per hue as the length of an arc corresponding to an angle of 10 degrees of the circumference.

Further, the color selecting section 415 detects the magnitude of a movement change by the circular motion operation of the electronic pen 3 for hue selection. When the magnitude of the movement change is larger than the hue change unit arc length, the color selecting section 415 detects that a change larger than one angular range in the hue selection table information has occurred and that a hue is changed. Further, the color selecting section 415 detects a factor by which the magnitude of the movement change by the circular motion operation of the electronic pen 3 for hue selection is larger than the hue change unit arc length, and the color selecting section 415 changes the angular range position in the hue selection table information, that is, changes the hue, by an amount corresponding to the detected factor.

Hence, when the radius of the reference standard circular motion operation is small, the length of the arc of the hue reference information is small, and hence, the hue can be changed by a slight circular motion operation. When the radius of the reference standard circular motion operation is large, on the other hand, the length of the arc of the hue reference information is large, and hence, the hue is not changed unless a circular motion operation is performed over a long distance. This is convenient for finely adjusting the change in hue.

Incidentally, in the present example, as the circular motion operation, operations in a clockwise direction and a counterclockwise direction opposite to the clockwise direction can be performed, and the hue can be changed in directions opposite from each other. Moreover, as described earlier, the hue being selected is indicated and displayed by the mark MKh in the color selection guide figure GCrS illustrated in FIG. 8.

Saturation reference information for referring to the saturation selection table information is a linear movement length in the reference standard rectilinear motion operation for saturation which corresponds to the length of one positional range on a reference straight line in the saturation selection table information (which will hereinafter be referred to as a saturation change unit length). The color selecting section 415 detects the length of the reference standard rectilinear motion operation for saturation from the sensor outputs of the acceleration sensor 351 and the gyro sensor 352 and a movement time with regard to the reference standard rectilinear motion operation of the electronic pen 3 for saturation in the three-dimensional space which is detected by the electronic pen movement detecting section 414, and in the present example, the color selecting section 415 calculates the saturation change unit length corresponding to a positional range per saturation value as a length of one hundredth of the length of the reference standard rectilinear motion operation.

Further, the color selecting section 415 detects the length of a linear movement change by the rectilinear motion operation of the electronic pen 3 for saturation selection. When the length of the movement change is larger than the saturation change unit length, the color selecting section 415 detects that a change larger than one positional range in the saturation selection table information has occurred and that a saturation is changed. Further, the color selecting section 415 detects a factor by which the length of the movement change by the rectilinear motion operation of the electronic pen 3 for saturation selection is larger than the saturation change unit length, and the color selecting section 415 changes the positional range in the saturation selection table information, that is, changes the saturation, by an amount corresponding to the detected factor.

Hence, when the linear length of the reference standard rectilinear motion operation for saturation is short, the saturation change unit length is short, and hence, the saturation can be changed by a slight rectilinear motion operation. When the length of the reference standard rectilinear motion operation for saturation is long, on the other hand, the saturation change unit length is lengthened, and hence, the saturation is not changed unless a rectilinear motion operation is performed over a long distance. This is convenient for finely adjusting the change in saturation.

Incidentally, in the present example, as the rectilinear motion operation for saturation, movement operations in directions opposite from each other are possible within a plane parallel with the display screen of the flat display 41, and changing the direction of the rectilinear motion operation for saturation can make the change in saturation in an opposite direction. Moreover, the value of the saturation being selected is indicated and displayed by the mark MKs in the color selection guide figure GCrS illustrated in FIG. 8.

In addition, also in lightness selection, operations similar to those of the saturation selection described above are performed.

### Example of Flow of Color Selecting Operation in Color Selecting Section 415 of Information Processing Circuit 410

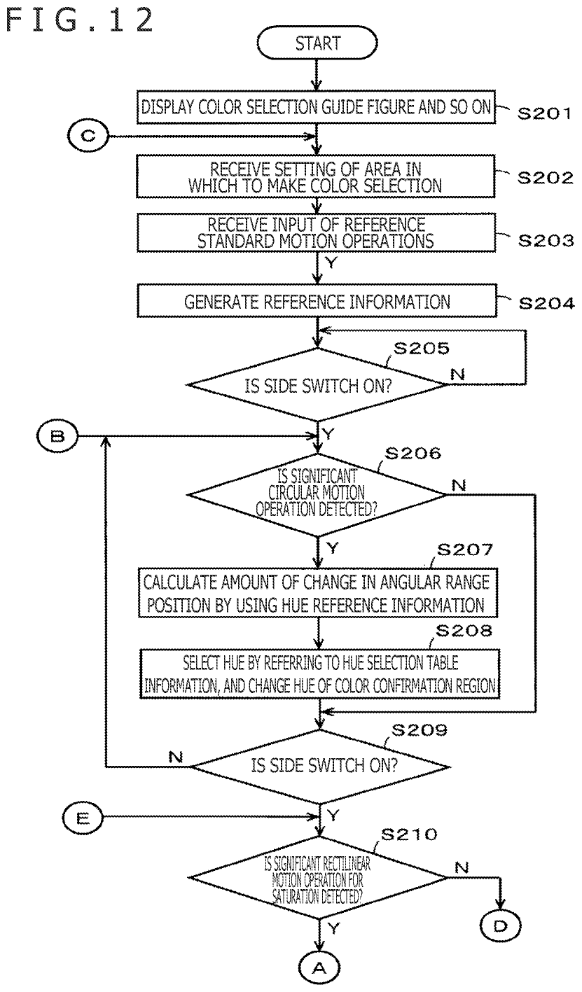

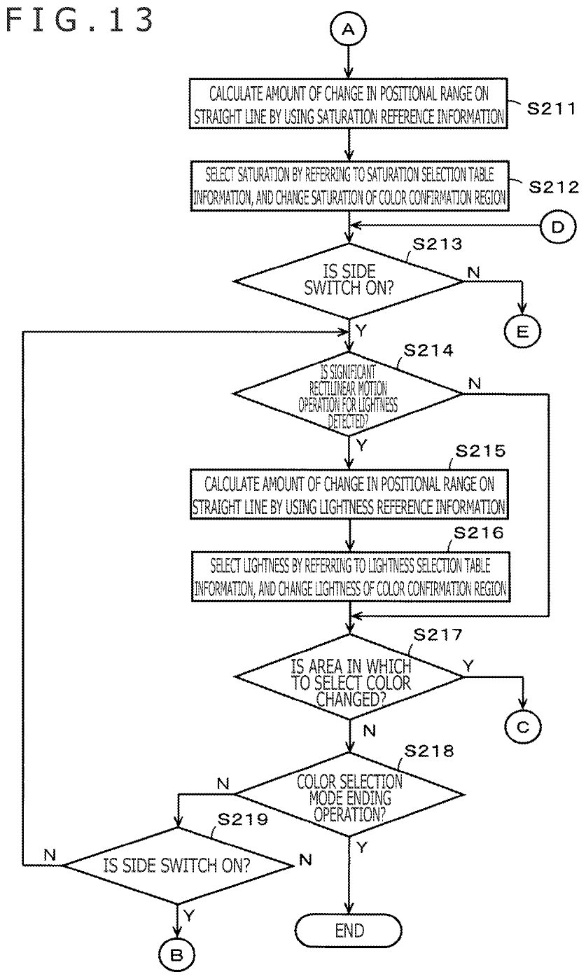

An example of a flow of a color selecting operation in the color selecting section 415 in the information processing circuit 410 configured as described above will be described with reference to a flowchart of FIG. 12 and FIG. 13, with FIG. 13 as a continuation from FIG. 12. Incidentally, the following description will be made of a case where the control section 411 of the information processing circuit 410 performs functions of the display information generating section 412, the electronic pen indication input detecting section 413, the electronic pen movement detecting section 414, and the color selecting section 415 as software function processing using a program.

As described earlier, in the tablet device 4, when the color selection mode is selected by the user, the control section 411 starts operation from a start of FIG. 12, first generates the color selection guide figure GCrS and the color confirmation region ACrS, and displays the color selection guide figure GCrS and the color confirmation region ACrS in a region on the left side of the display screen of the flat display 41, as illustrated in FIG. 8 (S201). Incidentally, in the color selection guide figure GCrS displayed here, the marks MKh, MKs, and MKv are displayed at positions corresponding to a default hue, a default saturation value, and a default lightness value, and a color at this time is displayed in the color confirmation region ACrS. The default hue, the default saturation value, and the default lightness value may be a specific hue and specific values determined in advance, or may be what is generally called last memory information stored as a hue and values selected in an immediately preceding color selection.

Next, the control section 411 notifies the user of a message prompting designation (setting) of an area (color setting target region) in which to make a color selection, in a display image displayed on the display screen of the flat display 41, and receives a setting of the area in which to make a color selection (S202). At this time, the positions of the marks MKh, MKs, and MKv in the color selection guide figure GCrS represent the hue, the saturation value, and the lightness value of the color of an area set as the area in which to make a color selection. However, the user may be allowed to select whether to use default or last memory information as it is or use the hue, the saturation value, and the lightness value of the color of the color setting target region.

Next, the control section 411 gives notification of a message prompting performance of the reference standard circular motion operation and the reference standard rectilinear motion operations for saturation and for lightness, and receives the input of these reference standard motion operations (S203). Then, as described above, the control section 411 calculates the hue change unit arc length as the reference information for hue in reference to the received reference standard circular motion operation, calculates the saturation change unit length as the reference information for saturation in reference to the reference rectilinear motion operation for saturation, and calculates a lightness change unit length as reference information for lightness in reference to the reference rectilinear motion operation for lightness (S204).

Next, the control section 411 monitors the state information of the side switch 37, and waits for the side switch 37 to be turned on (S205). When the control section 411 determines that the side switch 37 is turned on, the control section 411 determines that a state for receiving a hue selecting operation is set, and determines whether or not a significant circular motion operation of the electronic pen 3 is detected (S206). Here, the significant circular motion operation refers to a circular motion operation larger than the hue change unit arc length.

When the control section 411 determines at S206 that a significant circular motion operation is detected, the control section 411 detects a factor by which the magnitude of the detected circular motion operation is larger than the hue change unit arc length, and the control section 411 calculates a change amount converted into an angular range position(s) in the hue selection table information (S207). In the present embodiment, the control section 411 is configured to store the angular range position of a last selected hue in the hue selection table information. The control section 411 selects the hue of an angular range position corresponding to the change amount calculated at S207, by referring to the hue selection table information, changes the display position of the mark MKh accordingly, and changes the hue of the color of the color confirmation region ACrS (S208).

Next, the control section 411 monitors the state information of the side switch 37, and determines whether or not the side switch 37 is turned on (S209). In addition, also when the control section 411 determines at S206 that no significant circular motion operation is detected, the control section 411 jumps to S209 to determine whether or not the side switch 37 is turned on.

When the control section 411 determines at S209 that the side switch 37 is not turned on, the control section 411 returns the processing to S206, and repeats the above-described processing from S206 on down for receiving a selection of a hue.

In addition, when the control section 411 determines at S209 that the side switch 37 is turned on, the control section 411 determines that a state for receiving a saturation selecting operation is set, and determines whether or not a significant rectilinear motion operation of the electronic pen 3 for saturation is detected (S210). Here, the significant rectilinear motion operation for saturation refers to a rectilinear motion operation for saturation which has a length larger than the saturation change unit length.

When the control section 411 determines at S210 that a significant rectilinear motion operation for saturation is detected, the control section 411 detects a factor by which the magnitude of the detected rectilinear motion operation for saturation is larger than the saturation change unit length, and calculates a change amount converted into a positional range(s) in the saturation selection table information (S211 in FIG. 13). In the present embodiment, the control section 411 is configured to store the positional range of a last selected saturation value in the saturation selection table information. The control section 411 selects the saturation value of a positional range corresponding to the change amount calculated at S211, by referring to the saturation selection table information, changes the display position of the mark MKs accordingly, and changes the saturation value of the color of the color confirmation region ACrS (S212).

Next, the control section 411 monitors the state information of the side switch 37, and determines whether or not the side switch 37 is turned on (S213). In addition, also when the control section 411 determines at S210 that no significant rectilinear motion operation for saturation is detected, the control section 411 jumps from S210 to S213 to determine whether or not the side switch 37 is turned on.

When the control section 411 determines at S213 that the side switch 37 is not turned on, the control section 411 returns the processing to S210 in FIG. 12, and repeats the above-described processing from S210 on down for receiving a selection of a saturation value.

Alternatively, when the control section 411 determines at S213 that the side switch 37 is turned on, the control section 411 determines that a state for receiving a lightness selecting operation is set, and determines whether or not a significant rectilinear motion operation of the electronic pen 3 for lightness is detected (S214). Here, the significant rectilinear motion operation for lightness refers to a rectilinear motion operation for lightness which has a length larger than the lightness change unit length.

When the control section 411 determines at S214 that a significant rectilinear motion operation for lightness is detected, the control section 411 detects a factor by which the magnitude of the detected rectilinear motion operation for lightness is larger than the lightness change unit length, and calculates a change amount converted into a positional range(s) in the lightness selection table information (S215). In the present embodiment, the control section 411 is configured to store the positional range of a last selected lightness value in the lightness selection table information. The control section 411 selects the lightness value of a positional range corresponding to the change amount calculated at S215 by referring to the lightness selection table information, changes the display position of the mark MKv accordingly, and changes the lightness value of the color of the color confirmation region ACrS (S216).

Next, the control section 411 determines whether or not the color setting target region is changed and set (S217). In addition, also when the control section 411 determines at S214 that no significant rectilinear motion operation for lightness is detected, the control section 411 jumps to S217 to determine whether or not the color setting target region is changed and set.

When the control section 411 determines at S217 that the color setting target region is changed and set, the control section 411 returns the processing to S202 in FIG. 12 to receive a setting of a new color setting target region, and repeats the processing from S202 on down.

In addition, when the control section 411 determines at S217 that the color setting target region is not changed and set, the control section 411 determines whether or not an operation of ending the color selection mode is performed (S218). When the control section 411 determines that the operation of ending the color selection mode is performed, the control section 411 ends the processing in the color selection mode.

Then, when the control section 411 determines at S218 that the operation of ending the color selection mode is not performed, the control section 411 monitors the state information of the side switch 37, and determines whether or not the side switch 37 is turned on (S219).

When the control section 411 determines at S219 that the side switch 37 is not turned on, the control section 411 returns the processing to S214, and repeats the above-described processing from S214 on down for receiving a selection of a lightness value. Alternatively, when the control section 411 determines at S219 that the side switch 37 is turned on, the control section 411 returns the processing to S206 in FIG. 12 to resume the above-described processing from S206 on down for receiving a selection of a hue, and repeats the processing from S206 on down.

As described above, the color selecting method according to the second embodiment can make a color selection according to the movements of the electronic pen 3 which are detected according to the sensor output of the movement detecting sensor 35 provided in the electronic pen 3. The use of the movement detecting sensor 35 enables a color selection to be made according to the movements of the electronic pen 3 in the three-dimensional space in the second embodiment. Hence, the user of the electronic pen 3 does not need to operate an icon, a switch, or the like for color selection, the icon, the switch, or the like being displayed on the display screen, to make a color selection. An effect of facilitating a color selecting operation is consequently produced.

Moreover, in the second embodiment described above, a configuration is adopted such that reference standard motion operations are performed before the color selection and the reference information for selecting a hue, a saturation, and a lightness is used. It is thereby possible to select change degrees (change speeds) of the hue, the saturation, and the lightness which correspond to motion quantities of the electronic pen 3 at times of selecting the hue, the saturation, and the lightness. This is therefore convenient.

Incidentally, in the second embodiment described above, in order to clarify respective selection modes for the hue, the saturation, and the lightness, switching between the respective selection modes for the hue, the saturation, and the lightness is performed by turning on the side switch. However, the motion operation for hue is a circular motion operation, the motion operation for saturation is a rectilinear motion operation, and the motion operation for lightness is a rectilinear motion operation in a direction orthogonal to the rectilinear motion operation for saturation. The motion operations can hence be distinguished from each other. Thus, it is also possible to perform the motion operations for respective selections of a hue, a saturation, and a lightness successively without performing the switching.

In addition, in the second embodiment described above, before the operations of selecting the hue, the saturation, and the lightness are performed, the reference standard circular motion operation and the reference standard linear motion operations of the electronic pen 3 are made to be performed in the three-dimensional space, and the reference information for each of the hue, the saturation, and the lightness, that is, the hue change unit arc length, the saturation change unit length, and the lightness change unit length, are set. However, the reference standard circular motion operation and the reference standard linear motion operations of the electronic pen 3 may be performed as position indications by the distal end portion of the core body 31 of the electronic pen 3 on the display screen of the flat display 41, or in turn the position detecting sensor 42, rather than the movements of the electronic pen 3 in the three-dimensional space. In that case, the color selecting section 415 of the information processing circuit 410 detects the reference standard circular motion operation and the reference standard rectilinear motion operations from detection outputs of the electronic pen indication input detecting section 413.

In addition, the hue change unit arc length, the saturation change unit length, and the lightness change unit length as reference information for referring to the hue selection table information, the saturation selection table information, and the lightness selection table information may be fixed values determined in advance, to thereby render unnecessary or omit the reference standard circular motion operation and the reference standard linear motion operations before the operations of selecting the hue, the saturation, and the lightness are performed.

It is to be noted that, while the circular motion operation for hue and the rectilinear motion operation for saturation are performed within a plane parallel with the display screen of the flat display 41 in the second embodiment described above, there is no limitation to this example. The circular motion operation for hue and the rectilinear motion operation for saturation may be performed within any plane in the three-dimensional space. In addition, it is not essential that the circular motion operation for hue and the rectilinear motion operation for saturation be performed within the same plane, and the circular motion operation for hue and the rectilinear motion operation for saturation may be performed within planes different from each other. This is very convenient for a color change when a picture is drawn in a virtual reality (VR) space.

In addition, in the second embodiment described above, a rectilinear motion operation of moving the electronic pen 3 in a direction parallel with the display screen of the flat display 41 in the air above the display screen of the flat display 41 is treated as a rectilinear motion operation for saturation, and a rectilinear motion operation of moving the electronic pen 3 in a direction intersecting or, for example, orthogonal to, the display screen of the flat display 41 is treated as a rectilinear motion operation for lightness. However, the rectilinear motion operation for saturation and the rectilinear motion operation for lightness may be interchanged with each other.

In addition, it suffices for the rectilinear motion operation for lightness to be distinguishable from the rectilinear motion operation for saturation. Hence, the rectilinear motion operation for lightness does not need to be in a direction orthogonal to the straight line of the rectilinear motion operation for saturation as in the above-described example, and it suffices for the rectilinear motion operation for lightness to intersect the straight line of the rectilinear motion operation for saturation.

In addition, in the above-described example, a plane in which the rectilinear motion operation for saturation is performed and a plane in which the rectilinear motion operation for lightness is performed are each assumed, and these planes intersect each other (are orthogonal to each other). However, when the direction of the rectilinear motion operation for saturation and the direction of the rectilinear motion operation for lightness intersect each other (are orthogonal to each other, for example), and for one rectilinear motion operation, the other is set as an intersecting direction rectilinear motion operation, the two motion operations can be distinguished from each other. Hence, the rectilinear motion operation for saturation (or for lightness) and the intersecting direction rectilinear motion operation for lightness (or for saturation) may be performed on the same plane.

In addition, in the second embodiment described above, the electronic pen 3 is an active capacitive type electronic pen, and the position detecting sensor 42 of the tablet device 4 is also of a capacitive type. However, as in the first embodiment, the electronic pen 3 and the position detecting sensor 42 of the tablet device 4 can be configured to be of the electromagnetic induction type. Also in that case, the sensor output of the movement detecting sensor 35 may be transmitted from the electronic pen 3 to the tablet device through the wireless communication sections, or may be transmitted to the tablet device 4 via the position detecting sensor 42 on a time-division basis together with the position detection signal by performing ASK modulation, OOK modulation, or the like.

Incidentally, in the description of the above-described second embodiment, the information regarding the pressure applied to the electronic pen 3 is transmitted from the electronic pen 3 to the tablet device 4 via the position detecting sensor 42. However, the information may be transmitted to the tablet device 4 through the wireless communication sections.

Incidentally, in the second embodiment, the color selection guide figure GCrS is used to refer to the positions of the hue, the saturation, and the lightness being selected, and is hence not essential. Therefore, the display of the color selection guide figure GCrS may be omitted.

### Third Embodiment

A third embodiment is a modification of a color selecting system in the second embodiment. A hardware configuration in the present third embodiment includes the electronic pen 3 and the tablet device 4 in the second embodiment. In the present third embodiment, operation in the information processing circuit 410 of the tablet device 4 is different from that in the second embodiment.

Specifically, in the third embodiment, the color selecting section 415 of the information processing circuit 410 of the tablet device 4 has not only the above-described color selecting function but also a function of generating a mixed color by mixing a plurality of colors in a mixing manner (mixing method) corresponding to a result of detection of movement of the electronic pen 3 from the electronic pen movement detecting section 414. Other configurations in the third embodiment are similar to those in the second embodiment.

In the third embodiment, a speed of mixing a plurality of colors (hues) is changed according to a result of detection of movement of the electronic pen 3. Moreover, a mixing rate of the colors (hues) in a predetermined time t is changed in a range of 0% to 100% by mixing the colors (hues) at a mixing speed corresponding to the movement of the electronic pen 3. Incidentally, the saturation and lightness of a color as a mixing result (mixed color) are determined by a method similar to that of the foregoing second embodiment after a hue is determined by the mixing.

In addition, in the third embodiment, when the plurality of colors each have a predetermined region, a change as to whether to mix the whole of the colors in one stroke or to partially mix the colors finely is made according to the movement of the electronic pen 3.

In the third embodiment, the display screen of the flat display 41 displays the plurality of colors to be mixed with each other in respective regions of a predetermined size, and the displayed plurality of colors are mixed with each other according to the movement of the electronic pen 3.

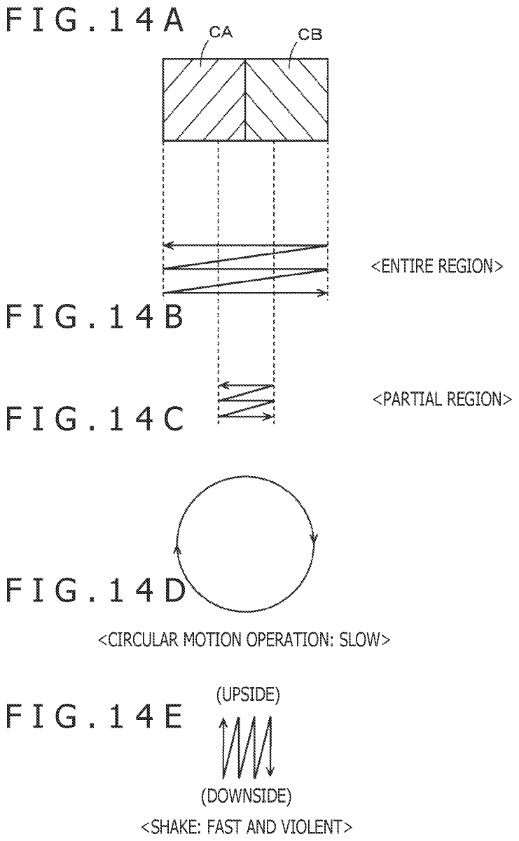

For example, as illustrated in FIG. 14A, two colors CA and CB to be mixed are adjacently separated from each other leftward and rightward, and are displayed in respective rectangular regions. Further, a mixing region for the two colors CA and CB is determined, for example, according to a swing width of an operation of swinging the electronic pen 3 leftward and rightward in a direction parallel with the display screen of the flat display 41 by performing rectilinear motion operation while maintaining a state in which the axial direction of the electronic pen 3 is orthogonal to the display screen of the flat display 41.

As illustrated in FIG. 14B, for example, when the swing width of the electronic pen 3 spans the entire rectangular regions of the two colors CA and CB, an instruction to mix the two colors CA and CB with each other in the entire regions of the two colors CA and CB in one stroke is assumed to be given. In addition, as illustrated in FIG. 14C, when the swing width of the electronic pen 3 is a part straddling the rectangular regions of the two colors CA and CB, an instruction to mix the two colors CA and CB with each other in a region of the designated part of the two colors CA and CB is assumed to be given.

Moreover, in the present third embodiment, when a circular motion operation of the electronic pen 3 is performed as illustrated in FIG. 14D, an instruction to slow the mixing speed is assumed to be given. In addition, when a shake operation of moving the electronic pen 3 up and down in the axial direction of the electronic pen 3 is performed, an instruction to increase the mixing speed or perform the mixing violently is assumed to be given.

It is needless to say that an example of the instructions for the mixing speed and the mixing region by the movements of the electronic pen 3 as described above is an example, and is not limited to the present example.

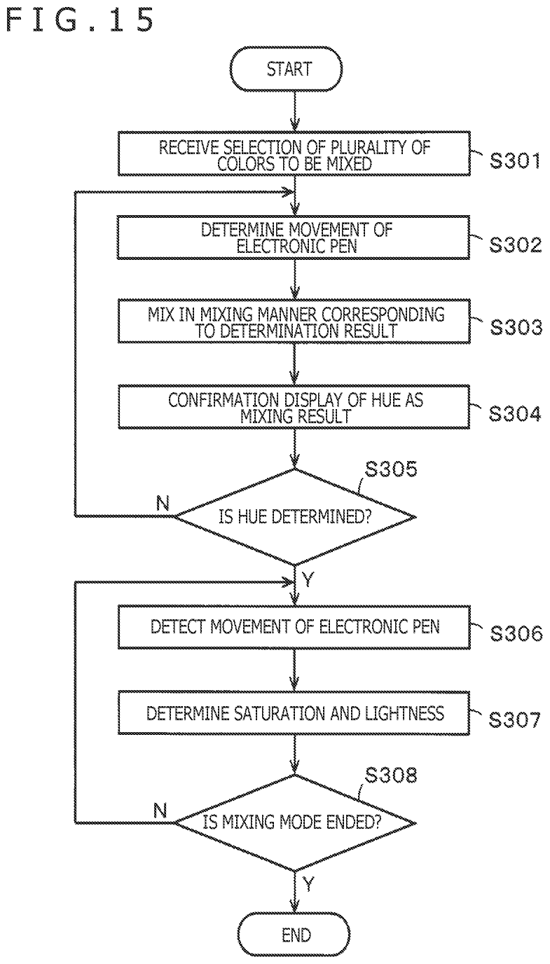

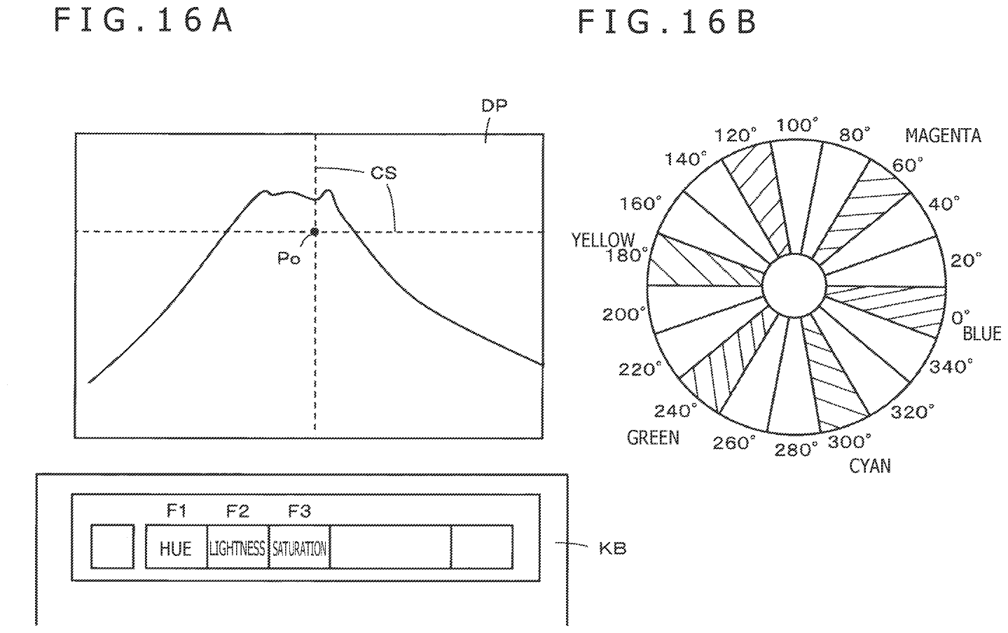

A flow of operation of color mixing processing in the information processing circuit 410 of the tablet device 4 according to the present third embodiment will next be described with reference to a flowchart of FIG. 15. Also in the flowchart of FIG. 15, as in the second embodiment, description will be made of a case where the control section 411 of the information processing circuit 410 performs functions of each part of the information processing circuit 410 as software function processing using a program.

As described earlier, in the tablet device 4, when the user selects a mixing mode for a plurality of colors from a processing function menu bar, the control section 411 starts operation from a start of FIG. 15, first notifies the user of a message prompting the user to select a plurality of colors to be mixed with each other, receives the plurality of colors selected in response to the message, and displays the plurality of colors on the display screen of the flat display 41 (S301).

Next, the control section 411 determines movement of the electronic pen 3 in the three-dimensional space which is detected by the electronic pen movement detecting section 414 from the sensor outputs of the acceleration sensor 351 and the gyro sensor 352, the sensor outputs being received from the electronic pen 3 (S302). That is, at S302, as described with reference to FIGS. 14A to 14E, determination is made with regard to the mixing speed and the mixing region.

Next, the control section 411 mixes the plurality of colors with each other at the mixing speed and in the mixing region that have been determined at S302, and obtains a hue as a mixing result by an additive method or a subtractive method (S303). Then, the control section 411 makes confirmation display of the color of the hue as a mixing result on the display screen of the flat display 41 (S304). This confirmation display may be made in a specially provided color confirmation region as in the foregoing embodiments. In the present example, however, the confirmation display is made in the mixing region set within a display region of the plurality of colors to be mixed with each other as illustrated in FIG. 14A.

Next, the control section 411 determines whether or not an operation indicating that a mixed color (hue) is determined is performed (S305). The determination processing at S305 is performed according to whether or not the side switch 37 in the electronic pen 3 is set in a long depressed on state, for example.

When the control section 411 determines at S305 that the operation indicating that the mixed color (hue) is determined is not performed, the control section 411 returns the processing to S302, and repeats the processing from S302 on down.

In addition, when the control section 411 determines at S305 that the operation indicating that the mixed color (hue) is determined is performed, the control section 411 detects, as movement of the electronic pen 3 in the three-dimensional space which is detected by the electronic pen movement detecting section 414, a rectilinear motion operation of the electronic pen 3 for saturation and a rectilinear motion operation of the electronic pen 3 for lightness as operations for selecting a saturation and a lightness as described in the foregoing second embodiment (S306).

Then, the control section 411 determines the movement of the electronic pen 3 which is detected at S306, and determines a saturation according to the rectilinear motion operation for saturation or determines a lightness according to the rectilinear motion operation for lightness (S307).

Next, the control section 411 determines whether or not an operation indicating an ending of the mixing mode for the plurality of colors is performed (S308). When the control section 411 determines that the operation is not performed, the control section 411 returns the processing to S306, and repeats the processing from S306 on down. When the control section 411 determines that the operation is performed, the control section 411 ends the mixing mode.

As described above, the third embodiment produces a remarkable effect of enabling the manner of mixing a plurality of colors to be adjusted easily according to the movement of the electronic pen 3.

Incidentally, while the foregoing third embodiment has been described as a modification of the second embodiment, the foregoing third embodiment can be treated as a modification of the first embodiment. That is, in a case of the modification of the first embodiment, the movement of the position indicated by the distal end portion of the core body 12 of the electronic pen 1 is detected instead of the movement of the electronic pen being detected with use of the sensor output of the movement detecting sensor, and the mixing speed and the mixing region are designated. Operations in the first embodiment are applicable as they are for selections of a saturation and a lightness at the hue as a mixing result.

### Other Embodiments or Modifications

Incidentally, while a pressure applied to the electronic pen is used for selection of a lightness in the foregoing first embodiment, it suffices to be able to make a distinction from the rectilinear motion operation for saturation, and hence, also in the first embodiment, an intersecting direction rectilinear motion operation in a direction intersecting the direction of the rectilinear motion operation for saturation may be used for selection of a lightness. In this case, as with the saturation selection table information illustrated in FIG. 5B, the lightness selection table information is generated in advance as correspondence information between each of positional ranges on a straight line and lightness values corresponding thereto. Further, a positional range on a straight line of the intersecting direction rectilinear motion operation is detected according to the output of the position detecting circuit 206, a positional range on a straight line having a reference length which corresponds to the detected positional range is detected, and a corresponding lightness is selected by reference to the lightness selection table information according to the detected positional range on the straight line having the reference length.

Incidentally, while the position indicator is an electronic pen in the cases of the foregoing embodiments, the position indicator is not limited to the electronic pen, and may have any shape as long as the position indicator has a function of performing signal interaction with the position detecting sensor.

In addition, the information processing device is not limited to the tablet device in the cases of the foregoing embodiments. For example, the information processing device may be configured by combining a digitizer including a position detecting sensor but not a display device such as a flat display with an apparatus such as a personal computer including a display device. Information concerning the movement of the position indicator such as the electronic pen in that case may be transmitted from the position indicator to the personal computer through the digitizer, or may be directly transmitted from the position indicator to the personal computer.

In addition, the information processing device may be configured as a personal computer including a position detecting sensor and a display device.

It is to be noted that the embodiment of the present disclosure is not limited to the foregoing embodiments, and that various changes can be made without departing from the spirit of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A color selecting method in an information processing device that performs signal interaction with a position indicator, the color selecting method comprising:
detecting a circular motion operation of the position indicator according to the signal interaction with the position indicator, and selecting a hue according to the circular motion operation;
detecting a rectilinear motion operation of the position indicator according to the signal interaction with the position indicator, and selecting a first one of a saturation or a lightness according to the rectilinear motion operation;
detecting a displacement quantity or a displacement position based on a movement of the position indicator in a direction intersecting a direction of the rectilinear motion operation according to the signal interaction with the position indicator, and selecting a second one of the saturation or the lightness according to the displacement quantity or the displacement position based on the movement of the position indicator in the direction intersecting the direction of the rectilinear motion operation; and
selecting a color based on the hue selected according to the circular motion operation, the first one of the saturation or the lightness selected according to the rectilinear motion operation, and the second one of the saturation or the lightness selected according to the displacement quantity or the displacement position.

2. The color selecting method according to claim 1, wherein:
the detecting the circular motion operation of the position indicator includes detecting an angular position on a circumference in the circular motion operation of the position indicator according to the signal interaction with the position indicator, and the selecting the hue includes selecting the hue according to the angular position from among different hues assigned according to angular positions on the circumference,
the detecting the rectilinear motion operation of the position indicator includes detecting a position on a straight line in the rectilinear motion operation of the position indicator according to the signal interaction with the position indicator, and the selecting the first one of the saturation or the lightness includes selecting the first one of the saturation or the lightness according to the position on the straight line from among one of a saturation group or a lightness group that is assigned different values according to positions on the straight line, and
the detecting the displacement quantity or the displacement position includes detecting the displacement quantity or the displacement position based on the movement of the position indicator in the direction intersecting the direction of the rectilinear motion operation, according to the signal interaction with the position indicator, and the selecting the second one of the of the saturation or the lightness includes selecting the second one of the saturation or the lightness according to the displacement quantity or the detected displacement position in a displacement of a state of the position indicator from among the second one of the saturation group or the lightness group that is assigned different values according to displacement quantities or displacement positions based on movements of the position indicator in the direction intersecting the direction of the rectilinear motion operation.

3. The color selecting method according to claim 1, wherein:
the rectilinear motion operation of the position indicator is a rectilinear motion operation in a circular plane including a circumference formed by the circular motion operation of the position indicator, and the movement of the position indicator is in a direction intersecting the circular plane.

4. The color selecting method according to claim 1, wherein:
the position indicator includes a pressure detector which, in operation, detects a pressure applied to a position indicating portion of the position indicator, and
the displacement quantity based on the movement of the position indicator is the pressure detected by the pressure detector.

5. The color selecting method according to claim 1, wherein:
the movement of the position indicator is an intersecting direction rectilinear motion operation of the position indicator in the direction intersecting the direction of the rectilinear motion operation of the position indicator, and the displacement position based on the movement of the position indicator is a position on a straight line in the intersecting direction rectilinear motion operation of the position indicator.

6. The color selecting method according to claim 1, wherein:
the circular motion operation of the position indicator is a circular motion operation of a position indicating portion of the position indicator,
the rectilinear motion operation of the position indicator is a rectilinear motion operation of the position indicating portion of the position indicator, and
the movement of the position indicator is a movement of the position indicating portion of the position indicator.

7. The color selecting method according to claim 6, wherein:
the information processing device includes a position detecting circuit including a position detecting sensor which, in operation, detects a position indicated by the position indicating portion of the position indicator,
the circular motion operation of the position indicator is detected from a detection output of the indicated position by the position detecting circuit,
the rectilinear motion operation of the position indicator is detected from the detection output of the indicated position by the position detecting circuit, and
the displacement quantity or the displacement position is detected by detecting a pressure applied to the position indicating portion of the position indicator.

8. The color selecting method according to claim 2, wherein:
the circular motion operation of the position indicator is a circular motion operation of a position indicating portion of the position indicator,
the rectilinear motion operation of the position indicator is a rectilinear motion operation of the position indicating portion of the position indicator, and
the movement of the position indicator is a movement of the position indicating portion of the position indicator.

9. The color selecting method according to claim 8, wherein:
the information processing device includes a position detecting circuit including a position detecting sensor which, in operation, detects a position indicated by the position indicating portion of the position indicator,
the circular motion operation of the position indicator is detected from a detection output of the indicated position by the position detecting circuit, and an angular position of the position indicating portion of the position indicator on the circumference is detected from the detection output of the indicated position by the position detecting circuit,
the rectilinear motion operation of the position indicator is detected from the detection output of the indicated position by the position detecting circuit, and a position of the position indicating portion of the position indicator on the straight line is detected from the detection output of the indicated position by the position detecting circuit, and
the displacement quantity or the displacement position is detected by detecting a pressure applied to the position indicating portion of the position indicator.

10. The color selecting method according to claim 2, wherein:
the position indicator includes a motion sensor, and transmits a sensor output of the motion sensor to the information processing device, and,
according to the sensor output from the motion sensor, the circular motion operation of the position indicator and the angular position on the circumference are detected, the rectilinear motion operation of the position indicator and the position on the straight line are detected, and the displacement quantity or the displacement position of the position indicator is detected.

11. The color selecting method according to claim 10, wherein:
the motion sensor includes an acceleration sensor or a gyro sensor.

12. The color selecting method according to claim 1, further comprising:
after receiving a selection of a plurality of colors different from each other, receiving a selection of a mode of mixing the plurality of colors; and
generating a color obtained by mixing the plurality of colors by a mixing method corresponding to the movement of the position indicator in the mode of mixing the colors selected.

13. A color selecting apparatus comprising:
a position indicator; and
an information processing device which, in operation, performs signal interaction with the position indicator,
wherein the information processing device includes:
a processor; and
a memory storing instructions that, when executed the processor, cause the information processing device to:
detect a circular motion operation of the position indicator, detect a rectilinear motion operation of the position indicator, and detect a displacement quantity or a displacement position based on a movement of the position indicator in a direction intersecting a direction of the rectilinear motion operation of the position indicator, according to the signal interaction with the position indicator, and
select a color of a hue, a saturation, and a lightness according to the circular motion operation of the position indicator, the rectilinear motion operation of the position indicator, and the displacement quantity or the displacement position based on the movement of the position indicator in the direction intersecting the direction of the rectilinear motion operation.

14. The color selecting apparatus according to claim 13, wherein:
the instructions, when executed the processor, cause the information processing device to, according to the signal interaction with the position indicator, detect an angular position on a circumference in the circular motion operation of the position indicator, detect a position on a straight line in the rectilinear motion operation of the position indicator, and detect the displacement quantity or the displacement position based on the movement of the position indicator in the direction intersecting the direction of the rectilinear motion operation of the position indicator,
wherein the information processing device stores color selection table information including first table information having different hues assigned to angular positions different from each other on the circumference in the circular motion operation of the position indicator, second table information having a first one of a saturation group or a lightness group, the first one of the saturation group or the lightness group including different values assigned to positions different from each other on the straight line in the rectilinear motion operation of the position indicator, and third table information having a second one of the saturation group or the lightness group, the second one of the saturation group or the lightness group including different values assigned to displacement quantities or displacement positions different from each other, the displacement quantities or the displacement positions being based on movements of the position indicator in the direction intersecting the direction of the rectilinear motion operation of the position indicator, and
the instructions, when executed the processor, cause the information processing device to select the color of the hue, the saturation, and the lightness by referring to the color selection table information, according to the angular position in the circular motion operation of the position indicator, the position on the straight line formed by the rectilinear motion operation of the position indicator, and the displacement quantity or the displacement position based on the movement of the position indicator in the direction intersecting the direction of the rectilinear motion operation.

15. The color selecting apparatus according to claim 13, wherein:
the information processing device includes a position detecting circuit including a position detecting sensor which, in operation, detects a position indicated by a position indicating portion of the position indicator,
the position indicator includes a pressure detector which, in operation, detects a pressure applied to the position indicating portion, and
the displacement quantity based on the movement of the position indicator is in a direction orthogonal to the direction of the rectilinear motion operation of the position indicator, the displacement quantity being detected is the pressure detected by the pressure detector.

16. The color selecting apparatus according to claim 13, wherein:
the movement of the position indicator in the direction intersecting the direction of the rectilinear motion operation of the position indicator is an intersecting direction rectilinear motion operation of the position indicator in the direction intersecting the direction of the rectilinear motion operation of the position indicator, and the displacement position based on the movement of the position indicator is a position on a straight line in the intersecting direction rectilinear motion operation of the position indicator.

17. The color selecting apparatus according to claim 13, wherein:
the position indicator includes a motion sensor and a transmitting circuit which, in operation, transmits a detection output of the motion sensor to the information processing device, and
the instructions, when executed the processor, cause the information processing device to receive the detection output of the motion sensor from the transmitting circuit of the position indicator, and detect each of the circular motion operation of the position indicator, the rectilinear motion operation of the position indicator, and the movement of the position indicator and the displacement quantity based on the movement of the position indicator, according to the detection output of the motion sensor.

18. The color selecting apparatus according to claim 13, wherein:
the position indicator includes a first wireless communication circuit which, in operation, transmits a detection output of a motion sensor to the information processing device, and
the information processing device includes a second wireless communication circuit which, in operation, receives the detection output of the motion sensor, the detection output being transmitted through the first wireless communication circuit of the position indicator.

19. The color selecting apparatus according to claim 13, wherein:
in the information processing device, the rectilinear motion operation of the position indicator is a rectilinear motion operation in a circular plane including a circumference formed by the circular motion operation of the position indicator, the lightness is selected according to a movement of the position indicator in a direction orthogonal to the circular plane, and the hue, the saturation, and the lightness are selected by successive operations of the position indicator.

20. The color selecting apparatus according to claim 13, wherein:
the position indicator includes a switch operable by a user, and the position indicator, in operation, transmits information regarding an operation of the switch to the information processing device, and
the hue, the first one of the saturation or the lightness, and the second one of the saturation or the lightness are selected according to the information regarding the operation of the switch.

21. The color selecting apparatus according to claim 13, wherein:
the position indicator includes an electronic pen of an electromagnetic induction system.

22. The color selecting apparatus according to claim 13, wherein:
the position indicator includes an electronic pen of an active capacitive system.
